(19) United States
(12) Patent Application Publication
(10) Pub. No.: US 2013/0141735 A1
(43) Pub. Date: Jun. 6, 2013

(54) TARGET FOR LARGE SCALE METROLOGY SYSTEM

(71) Applicants: Michael Sogard, Menlo Park, CA (US); Alexander Cooper, Belmont, CA (US); W. Thomas Novak, Foster City, CA (US)

(72) Inventors: Michael Sogard, Menlo Park, CA (US); Alexander Cooper, Belmont, CA (US); W. Thomas Novak, Foster City, CA (US)

(21) Appl. No.: 13/488,322

(22) Filed: Jun. 4, 2012

Related U.S. Application Data
(60) Provisional application No. 61/495,255, filed on Jun. 9, 2011.

(51) Int. Cl. G01B 11/14

(52) U.S. Cl. CPC G01B 11/14
USPC 356/614

(57) ABSTRACT

A target (16) for a metrology system (10) that monitors the position of an object (12) includes a target housing (225) and a photo detector assembly (226). The target housing (225) can include a first target surface (218A), and a second target surface (218B) that is at an angle relative to the first target surface (218A). The photo detector assembly (226) can include a first detector (220A) that is secured to the first target surface (218A), and a second detector (220B) that is secured to the second target surface (218B). Each of the detectors (220A) (220B) can be a quad cell that includes four detector cells (238A) (238B) (238C) (238D) that are separated by a gap (236).

### RELATED APPLICATION

The application claims priority on Provisional Application Ser. No. 61/495,255 filed on Jun. 9, 2011, entitled “TARGET FOR LARGE SCALE METROLOGY SYSTEM”. As far as is permitted, the contents of U.S. Provisional Application Ser. No. 61/495,255 is incorporated herein by reference.

### BACKGROUND

Large scale metrology systems are used to monitor the position of one or more objects during an assembly or manufacturing procedure. There are a number of other potential applications too, e.g. measuring an object that's already been built, and/or monitoring a change in some object during the course of some events. There is an ever increasing need to improve the accuracy and performance of the metrology system, reduce the cost of the metrology system, and simplify the design of the metrology system.

### SUMMARY

The present invention is directed to a target for a metrology system that monitors an object. For example, the metrology system can be used to monitor the position of the object or to inspect the size or shape of the object. In one embodiment, the target includes a target housing and a photo detector assembly. The target housing can include an engaging surface that is adapted to engage the object, a first target surface, and a second target surface that is at an angle relative to the first target surface. The photo detector assembly can include a first detector that is secured to the first target surface and a second detector that is secured to the second target surface. As an overview, the multiple target surfaces and multiple unique, detectors provided herein provide greater sensitivity and higher resolution. This improves the positional accuracy of the system.

In one embodiment, the target housing can include a third target surface that is at an angle relative to the first target surface and the second target surface, and the photo detector assembly can include a third detector that is secured to the third target surface. In this embodiment, the target housing can be shaped somewhat similar to a tetrahedron.

In another embodiment, the target housing additionally includes a fourth target surface that is at an angle relative to the other target surfaces, a fifth target surface that is at an angle relative to the other target surfaces, and a sixth target surface that is at an angle relative to the other target surfaces; and the photo detector assembly includes a fourth detector that is secured to the fourth target surface, a fifth detector that is secured to the fifth target surface, and a sixth detector that is secured to the sixth target surface.

In still another embodiment, the target housing also includes a seventh target surface that is at an angle relative to the other target surfaces, an eighth target surface that is at an angle relative to the other target surfaces, and a ninth target surface that is at an angle relative to the other target surfaces; and the photo detector assembly includes a seventh detector that is secured to the seventh target surface, an eighth detector that is secured to the eighth target surface, and a ninth detector that is secured to the ninth target surface. In this embodiment, the target housing can be shaped somewhat similar to a decahedron.

In yet another embodiment, the target housing further includes a tenth target surface that is at an angle relative to the other target surfaces, and an eleventh target surface that is at an angle relative to the other target surfaces; and the photo detector assembly includes a tenth detector that is secured to the tenth target surface, and an eleventh detector that is secured to the eleventh target surface. In this embodiment, the target housing is shaped somewhat similar to a dodecahedron. Still alternatively, the target could have any number of target surfaces arranged in any geometric pattern.

In yet another embodiment, one or more of the target surfaces can include one or more detectors. For example, to manufacture a relatively large target surface with a detector at each end.

Additionally, the present invention is directed to a metrology system comprising a beam generator that generates a moving beam, and a plurality of targets. Further, the present invention is directed to a method for monitoring the position of an object.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a perspective view of a metrology system having features of the present invention that monitors the position of an object;

FIG. 1B is a front view of a transmitter from the metrology system of FIG. 1A;

FIG. 1C is a perspective view of the transmitter of FIG. 1B;

FIG. 1D is a perspective view of the transmitter and a target of the metrology system of FIG. 1A;

FIG. 2A is a side view, FIG. 2B is a top view, and FIG. 2C is a bottom view of a target having features of the present invention;

FIG. 2D is a bottom view of another embodiment of a target having features of the present invention;

FIG. 3A is a side view, FIG. 3B is a left end view, and FIG. 3C is a right end view of another embodiment of a target having features of the present invention;

FIG. 4A is a side view, FIG. 4B is a left end view, and FIG. 4C is a right end view of still another embodiment of a target having features of the present invention;

FIG. 5 is a side view of yet another embodiment of a target having features of the present invention;

FIG. 6 is a side view of still another embodiment of a target having features of the present invention;

FIG. 7 is a perspective view of still another embodiment of a target having features of the present invention;

FIG. 8 is a perspective view of another embodiment of a target having features of the present invention;

FIG. 9A is a perspective view of still another embodiment of a target having features of the present invention;

FIG. 9B is a perspective view of yet another embodiment of a target having features of the present invention;

FIG. 10A is a perspective view of another embodiment of a target having features of the present invention;

FIG. 10B is a perspective view of still another embodiment of a target having features of the present invention;

FIG. 10C is a perspective view of yet another embodiment of a target having features of the present invention;

FIG. 11 is a side view of another embodiment of a target having features of the present invention;

FIGS. 12A and 12B illustrate situations where a fan beam illuminates one or two detectors of a target;

FIG. 13 defines the coordinates of fan beams intercepting two detectors of a target;

FIGS. 14A-14D illustrate various orientations of a target intercepted by fan beams from two transmitters;

FIG. 15A illustrates a fan beam and detector, and FIGS. 15B-15E illustrate the detector signals for the detector as the fan beam is moved left to right over the detector, with the fan beam being parallel to a vertical gap in the detector;

FIG. 16A illustrates a fan beam and detector, and FIGS. 16B-16E illustrate the detector signals for the detector as the fan beam is moved left to right over the detector, with the fan beam being at an angle relative to the vertical gap in the detector;

FIGS. 17A and 17B illustrate different combinations of the detector signals from FIGS. 15B-15E;

FIGS. 18A and 18B illustrate different combinations of the detector signals from FIGS. 16B-16E; and

FIG. 19A illustrate the detector signals as a fan beam wider than a detector cell is moved left to right over the detector, with the fan beam being at an angle relative to the vertical gap in the detector, and FIGS. 19B, 19C illustrate different combinations of the detector signals from FIG. 19A;

FIG. 20 is a block diagram of a structure manufacturing system having features of the present invention; and

FIG. 21 is a flowchart showing processing flow of the structure manufacturing system of FIG. 20.

### DESCRIPTION

The present invention is directed to a large metrology system 10 for monitoring the position and/or shape of one or more objects 12 (e.g. a mechanical structure) during a manufacturing or assembly process, or an inspection process for example. In one embodiment, the metrology system 10 includes (i) one or more transmitters 14, (ii) one or more targets 16 that are attached to each object 12, and (iii) a control system 17 that receives information from the targets 16 and determines the position of the targets 16 and the object 12 relative to the transmitters 14. As an overview, in certain embodiments, each target 16 includes multiple target surfaces 18A-18C and multiple unique, detectors 20A-20C. As a result thereof, the target 16 provides greater sensitivity and higher resolution. This improves the accuracy of the metrology system 10. Further, the target 16 is relatively simple and inexpensive to manufacture, align and maintain. A metrology system 10 having features of the present invention (without the improvements to the target 16) is sold by Nikon Metrology under the trademark “iGPS”.

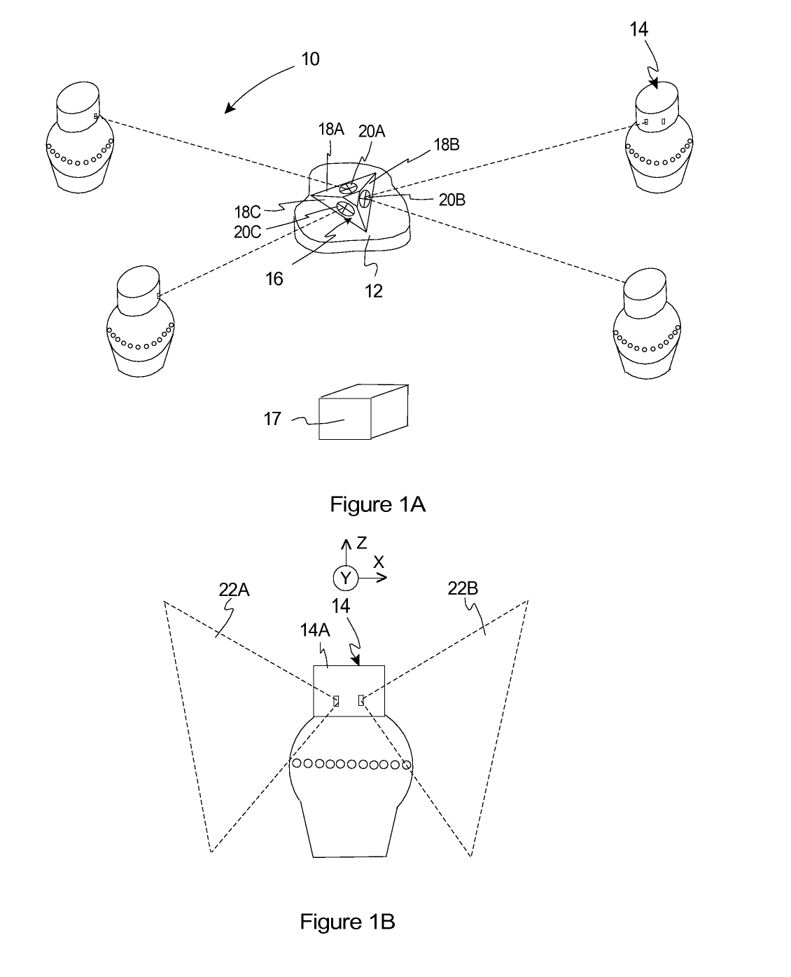

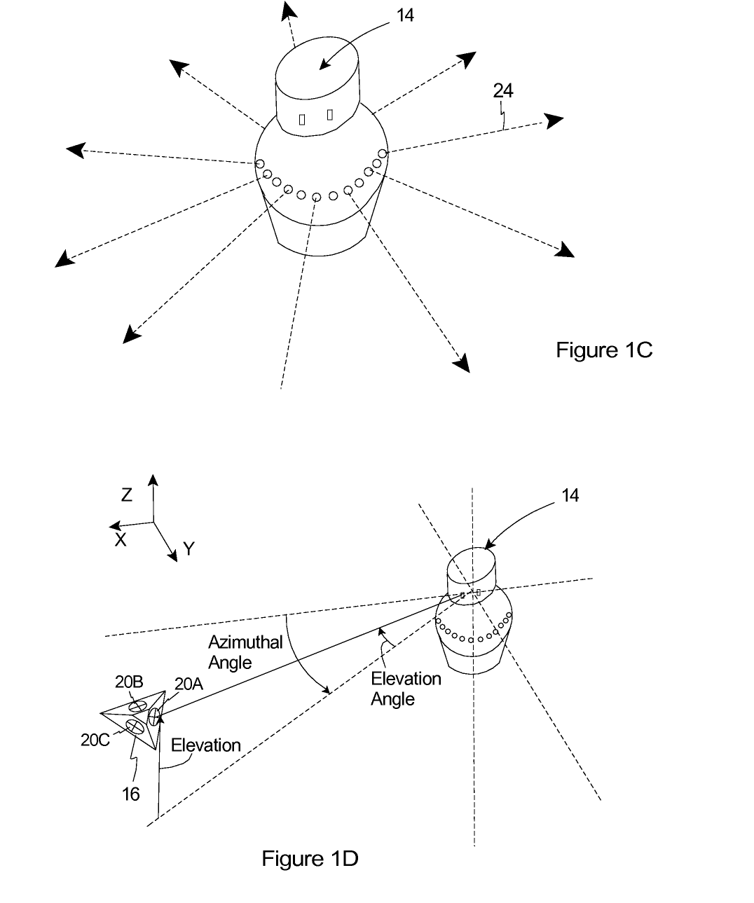

In FIG. 1A, the system 10 includes four spaced apart transmitters 14 that are used to determine the position of the target 16 and the object 12. The position of each of the transmitters 14 is known. Generally speaking, the positional accuracy improves as the number of transmitters 14 is increased. With the unique designs of the target 16 provided herein, in certain embodiments, a single transmitter 14 can be used to determine the position of a single target 16 (and the position of the object 12).

FIG. 1B is a front view of one of the transmitters 14. In this embodiment, the transmitter 14 includes a beam generator (not shown) that generates a pair of beams 22A, 22B that impinge on the target 16 (illustrated in FIG. 1A) to determine the position of the target 16 relative to the transmitter 14. In this embodiment, a head 14A of the transmitter 14 is rotating so that the beams 22A, 22B are rotating approximately about the Z axis. Stated in another fashion, the place where the beams 22A, 22B are emitting is rotated approximately about the Z axis so that the beams 22A, 22B are rotating.

In one non-exclusive embodiment, each of the beams 22A, 22B is a somewhat planar shaped beam, each beam 22A, 22B lies in a different plane, and is referred to herein as a fan beam. Further, in FIG. 1B, each of the beams 22A, 22B are angled relative to each other vertically (e.g. tilted inward from top to bottom). With this design, the beams 22A, 22B lie in planes that are at an angle relative to the Z axis. Further, the beams 22A, 22B are emitted from the transmitter 14 separated by a fixed azimuthal angle, and are limited in vertical extension by upper and lower elevation angles. With this design, the bottom of the beams 22A, 22B are closer together than the top of the beams 22A, 22B. Alternatively, the orientation of the beams 22A, 22B can be different than that illustrated in FIG. 1B. Alternatively, for example, the transmitter 14 can be designed so that the beams 22A, 22B lie in planes that are parallel to the Z axis.

Moreover, in one embodiment, the transmitter 14 includes a strobe pulse generator (not shown) that generates an azimuthal strobe pulse of light (also referred to as a timing pulse of light) once every revolution of the head 14A and the pulse of light is an infrared beam. Alternatively, the frequency of the pulses and the wavelength of the pulses can be different than the example provided herein. As provided herein, in certain embodiments, the pulse of light is used to identify the particular transmitter 14.

In one non-exclusive embodiment, each of the beams 22A, 22B has a wavelength of approximately 785 nanometers. However, other wavelengths for the beams 22A, 22B are possible.

Referring back to FIG. 1A, the control system 17 receives a first signal from the first detector 20A, a second signal from the second detector 20B, and a third signal from the third detector 20C. With this design, the control system 17 can individually determine when each beam 22A, 22B (illustrated in FIG. 1B) is incident on each detector 20A, 20B, 20C. Further, the control system 17 controls the operation of each transmitter 14. The control system 17 can include one or more processors. In FIG. 1A, the control system 17 is illustrated as a centralized system positioned away from the other components. Alternatively, the control system 17 can be a decentralized system with processors positioned in the targets 16 and/or the transmitters 14.

FIG. 1C is a perspective view of the transmitter 14 that illustrates that the azimuthal timing pulse of light 24 is emitted from around the center circumference of the transmitter 14. In FIG. 1C, only a portion of the timing pulse of light 24 is illustrated. Instead, light 24 is emitted from each of the ports.

FIG. 1D illustrates one target 16 and one transmitter 14. In this embodiment, the one transmitter 14 can be used to determine the azimuth and elevation of one or more of the detectors 20A-20C along a line relative to the transmitter 14. In this example, only the first detector 20A is in the path of the beams 22A, 22B (illustrated in FIG. 1B) from the transmitter 14. Thus, the control system 17 (illustrated in FIG. 1A) can analyze the first signal from the first detector 20A to determine the azimuth and elevation of the first detector 20A. Alternatively, if the target 16 was oriented so that the second detector 20B is in the path of the beams 22A, 22B, the control system 17 could analyze the second signal from the second detector 20B to individually determine the azimuth and elevation of the second detector 20B. Still alternatively, if the target 16 was oriented so that the third detector 20C is in the path of the beams 22A, 22B, the control system 17 could analyze the third signal from the third detector 20C to individually determine the azimuth and elevation of the third detector 20C.

In all of designs provided herein, the control system 17 can be used to individually determine the azimuth and elevation of the center of each detector that is impinged upon by the beams 22A, 22B.

The azimuth, or azimuthal angle, and elevation are defined relative to a polar coordinate system, whose z-axis coincides with the rotation axis of the fan beams 22A, 22B. The azimuthal plane, defined by z=0, is located approximately at the midpoint of the fan beams' vertical range. The azimuth is defined relative to the direction of the fan beams at the time of the azimuthal strobe pulse. This direction also defines the direction of the x axis of a Cartesian coordinate system, whose z axis coincides with the z-axis of the polar coordinate system. The height, or elevation, of each detector 20A-20C relative to the azimuthal plane is determined from the time interval between arrival of the first fan beam at the center of each detector 20A-20C and the arrival of the second fan beam, as well as the vertical angle between the fan beams. The elevation angle e of the detector 20A-20C is given by e=arcsin(height/R), where R is the distance from the origin (sometimes referred to as the “range”) of the transmitter's polar coordinate system to the center of the detector.

With the design of the target 16 illustrated in FIG. 1D, depending upon the orientation of the target 16, more than one transmitter 14 may be needed to determine the range and other positional information of the target 16. Alternatively, with the design of some of the targets 16 provided herein, a single transmitter 14 is all that is needed to determine the six degree of freedom position of the target 16 and hence the point of attachment of the target 16 to the object 12 (illustrated in FIG. 1A). For example, if the beams from a single transmitter 14 impinge upon three individual detectors 20A-20C, the strength of the signals, the timing of the signals, and the distance between the detectors 20A-20C can be analyzed to at least roughly determine the position of the target 16. However, the use of additional transmitters 14 and/or signals from additional detectors 20A-20C will improve the accuracy of the measurement.

Referring to FIGS. 1A-1D, with the present design, the metrology system 10 measures the distance and orientation of mechanical structures 12. Targets 16 are mounted at specific locations on the structures 12. The distance from each detector 20A-20C location to the contact position with the structure 12 is known. Depending upon the orientation of the target 16, the rotating laser fan beams 22A, 22B scan across one or more of the detectors 20A-20C on each targets 16. For each transmitter 14, the direction of the fan beams 22A, 22B are known as a function of time. When the fan beams 22A, 22B sweep across a detector 20A-20C on the target 16, it generates a signal whose time defines the direction of the fan beams 22A, 22B (azimuth angle relative to the transmitter 14) when they impinge on the respective detector 20A-20C. The time interval between the fan beam pulses is used to determine the elevation angle relative to the transmitter 14. Based on these two angles from several transmitters 14, the position of the target 16 can be calculated.

As discussed above, depending upon the design and orientation of the target 16, if the fan beams 22A, 22B of a single transmitter 16 impinge on only one detector 20A-20C, the information from the single detector 20A-20C can be used by the control system 17 to determine the azimuth and elevation of the center of the detector 20A-20C along a line relative to the transmitter 14. If the fan beams 22A, 22B of a single transmitter 16 impinge on two detectors 20A-20C, the information from the two detectors 20A-20C can be used by the control system 17 to determine the azimuth and elevation of the centers of the detectors 20A-20C relative to the transmitter 14. Still alternatively, if the fan beams 22A, 22B of a single transmitter 16 impinge on at least three detectors 20A-20C, the information from the at least three detectors 20A-20C can be used by the control system 17 to at least roughly determine the position of the target 16 with six degrees of freedom relative to the transmitter 14.

Further, multiple transmitters 14 at different, known locations can be used to determine the position of the target 16. The orientation can be determined by assembling the information from the detectors 20A-20C with the control system 17, in a known geometry and using the timing signals to work out the assembly orientation.

Three or more transmitters 14 can be used to provide redundancy and determine the position of the target 16 with improved accuracy. More specifically, the additional information from other transmitters 14 will provide additional three dimensional points that can be used to augment the six degree of freedom measurement or obtain an uncertainty estimate. Further, the use of numerous transmitters 14 will improve that likelihood that every target 16 is visible to the transmitters 14 as it is moved.

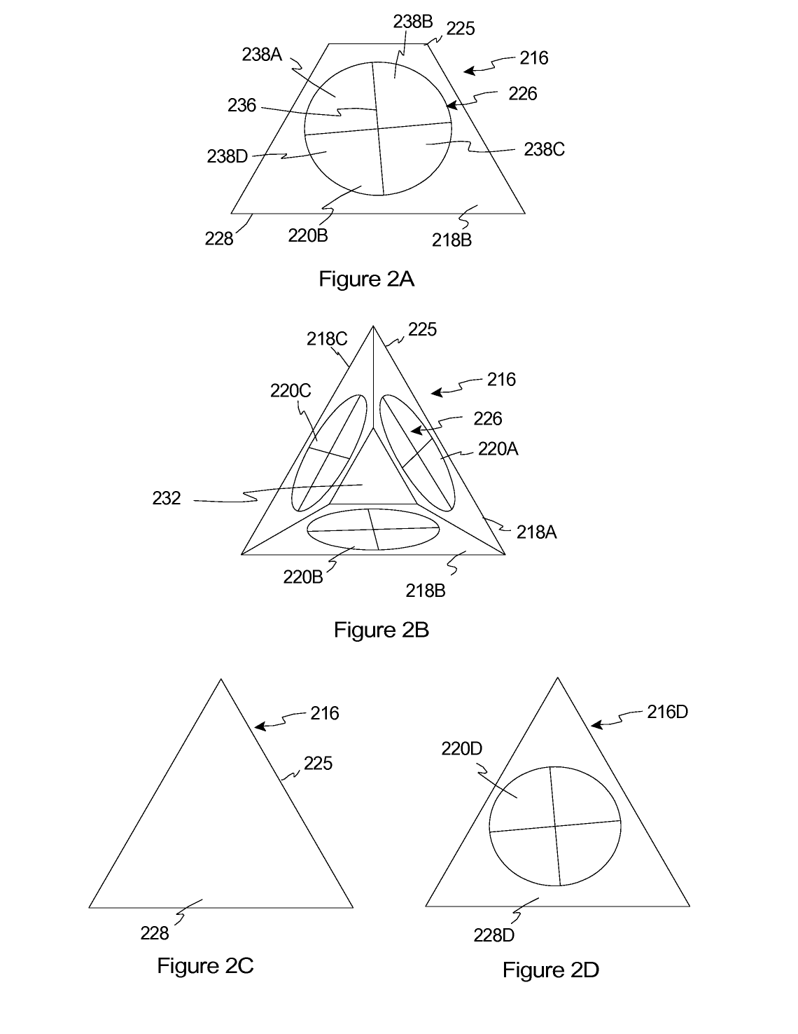

FIG. 2A is a side view, FIG. 2B is a top view, and FIG. 2C is a bottom view of a first embodiment of target 216. In one embodiment, the target 216 includes a target housing 225, and a photo detector assembly 226 mounted onto the target housing 225. In this embodiment, the target 216 includes multiple surfaces, and multiple detectors. More specifically, in this embodiment, the target housing 225 is truncated tetrahedron shaped (also truncated, three sided pyramid shaped) and includes (i) an engaging surface 228 (sometimes referred to as a “mounting surface”) which is at the bottom in FIG. 2B that is secured to the object 12 (illustrated in FIG. 1A), (ii) three side target surfaces, namely a first target surface 218A, a second target surface 218B, and a third target surface 218C that extend upward from the engaging surface 228, and (iii) an upper surface 232 that is parallel to and spaced apart from the engaging surface 228. In this embodiment, each of the surfaces 218A, 218B, 218C is trapezoidal shaped and each of the surfaces 228, 232 are triangular shaped. Alternatively, one or more of the surfaces can have another configuration, such as triangular. Non-exclusive examples of suitable materials for the target housing 225 include, but are not limited to, plastic, metal, ceramics, or composites.

Further, in this embodiment, each of the target surfaces 218A-218C is at an angle relative to the other target surfaces 218A-218C. For example, in FIGS. 2A-2B, the target surfaces 218A-218C are at an angle of approximately seventy degrees relative to each other. With this design, at least one of the target surfaces 218A-218C will be in the path of the moving fan beams 22A, 22B. Alternatively, the relative angles of the target surfaces 218A-218C can be different than seventy degrees as illustrated in some of the subsequent embodiments.

The photo detector assembly 226 detects the fan beams 22A, 22B as they are moved across the target 216. In this embodiment, the photo detector assembly 226 includes multiple detectors that are secured to the different target surfaces 218A-218C of the target housing 225. More specifically, in this embodiment, the photo detector assembly 226 includes (i) a first detector 220A that is secured to and positioned on the first target surface 218A, (ii) a second detector 220B that is secured to and positioned on the second target surface 218B, and (iii) a third detector 220C that is secured to and positioned on the third target surface 218C. In this embodiment, the detectors 220A-220C are mounted on faces of the tetrahedron shaped target housing 225. With this design, the target 216 is sensitive to signals over a hemisphere, and depending on the orientation of the target 216, the fan beams 22A, 22B from one transmitter 14 (illustrated in FIG. 1B) will impinge upon either zero, one, two, or three detectors 220A-220C during movement of the fan beams 22A, 22B over the target 216.

The design of each detector 220A-220C can be varied pursuant to the teachings provided herein. In certain embodiments, each detector 220A-220C can be a position sensitive detector, such as a split cell detector. As one non-exclusive embodiment, one or more of the detectors 220A-220C can be a photodiode quad cell detector. In this embodiment, each detector 220A-220C is generally circular shaped and (as best seen in FIG. 2A) is divided by a plus “+” shaped divider 236. Each detector 220A-220C can also have a square shape or another shape.

In this embodiment, the divider 236 defines a center gap that divides each detector 220A-220C to define four separate, equally sized, detector cells, namely a first detector cell 238A (sometimes referred to as the “A cell”), a second detector cell 238B (sometimes referred to as the “B cell”), a third detector cell 238C (sometimes referred to as the “C cell”), and a fourth detector cell 238D (sometimes referred to as the “D cell”). Each detector cell 238A-238D is able to measure light at the wavelength of the fan beams 22A, 22B and the wavelength of the pulses of light 24 (illustrated in FIG. 1C). In this embodiment, each detector cell 238A-238D can provide an individual cell signal, and, for example, the cell signals for each detector 220A-220C can be analyzed to determine when each beam 22A, 22B impinges on a center of respective detector 220A-220C. For example, each detector cell 238A-238D can be a photodiode. As provided herein, each quad cell detector 220A-220C provides good signal sensitivity with very good timing resolution. As one non-exclusive example, a suitable quad cell detector 220A-220C has a diameter of between approximately four millimeters and ten millimeters. Alternatively, the diameter can be greater or less than these sizes.

As provided herein, the split detectors 220A-220C (e.g. the quad detectors) respond to any orientation of the fan beams 22A, 22B. In certain embodiments, the position resolution of the split detector 220A-220C depends on the width of the divider 236 (e.g. the gap), not the detector size, so the detector elements 220A-220C can be relatively large, leading to relatively high sensitivity.

FIG. 2D is a bottom view of another embodiment of a target 216D that is somewhat similar to the target 216 described above and illustrated in FIGS. 2A-2C. However, in this embodiment, the bottom surface 228D includes a fourth split detector 220D and the upper surface (not shown) can be contacting and secured to the object 12 (illustrated in FIG. 1A).

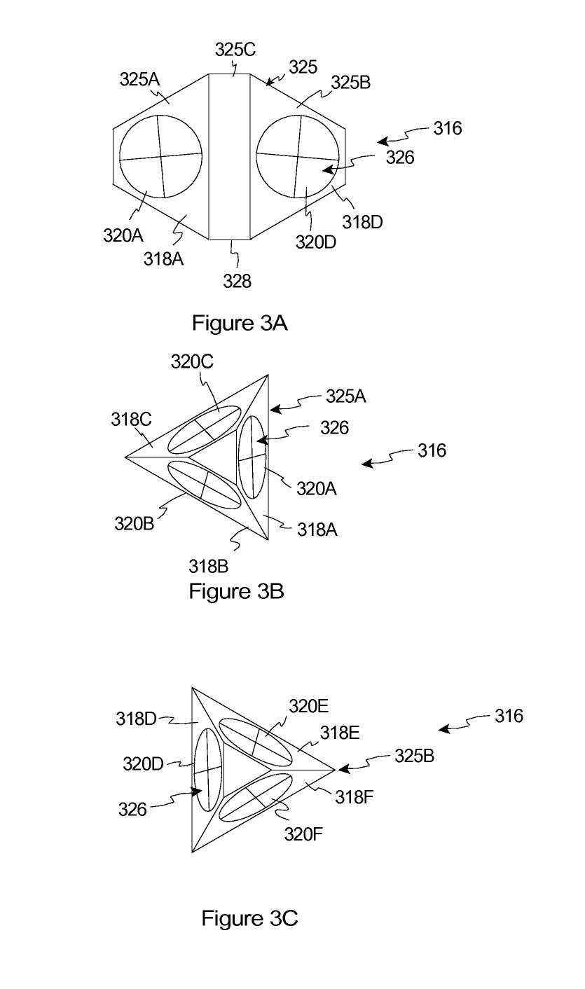

FIG. 3A is a side view, FIG. 3B is a left end view, and FIG. 3C is a right end view of another embodiment of a target 316 having features of the present invention. In this embodiment, the target 316 includes (i) a target housing 325 that is shaped similar to two truncated tetrahedrons attached together with a spacer therebetween (which can house electronics of the target 316) and (ii) a photo detector assembly 326 mounted onto the target housing 325.

In this embodiment, the target housing 325 includes (i) a first region 325A that is shaped similar to truncated tetrahedron; (ii) a second region 325B that is shaped similar to truncated tetrahedron; and (iii) a center region 325C that is shaped similar to a triangle and that is positioned between and secures the first region 325A to the second region 325B. In this embodiment, (i) the first region 325A includes three side target surfaces, namely a first target surface 318A, a second target surface 318B, and a third target surface 318C; (ii) the second region 325B includes three side target surfaces, namely a fourth target surface 318D, a fifth target surface 318E, and a sixth target surface 318F; and (iii) the center region 325C includes an engaging surface 328 that engages and mounts to the object 12 (illustrated in FIG. 1A). Alternatively, for example, the engaging surface 328 can be at one of the tops of the first or second regions 325A, 325B. In this embodiment, each of the target surfaces 318A-318F is trapezoidal shaped, and at an angle relative to the other target surfaces 318A-318B.

Again, in this embodiment, the photo detector assembly 326 detects the fan beams 22A, 22B as they are moved across the target 316. In FIGS. 3A-3C, the photo detector assembly 326 includes (i) a first detector 320A that is secured to and positioned on the first target surface 318A and that provides a first signal, (ii) a second detector 320B that is secured to and positioned on the second target surface 318B and that provides a second signal, (iii) a third detector 320C that is secured to and positioned on the third target surface 318C and that provides a third signal, (iv) a fourth detector 320D that is secured to and positioned on the fourth target surface 318D and that provides a fourth signal, (v) a fifth detector 320E that is secured to and positioned on the fifth target surface 318E and that provides a fifth signal, and (vi) a sixth detector 320F that is secured to and positioned on the sixth target surface 318F and that provides a sixth signal.

In this embodiment, the detectors 320A-320F are mounted on faces of the two tetrahedron shaped regions 325A, 325B. With this design, the target 316 is sensitive to signals over a hemisphere, and depending on the orientation of the target 316, the fan beams 22A, 22B from one of the transmitters (illustrated in FIG. 1B) will impinge upon either two or four detectors 320A-320F during movement of the fan beams 22A, 22B over the target 316. In this embodiment, one or more of the detectors 320A-320F can be similar to the detectors 220A-220C described above and illustrated in FIGS. 2A-2C.

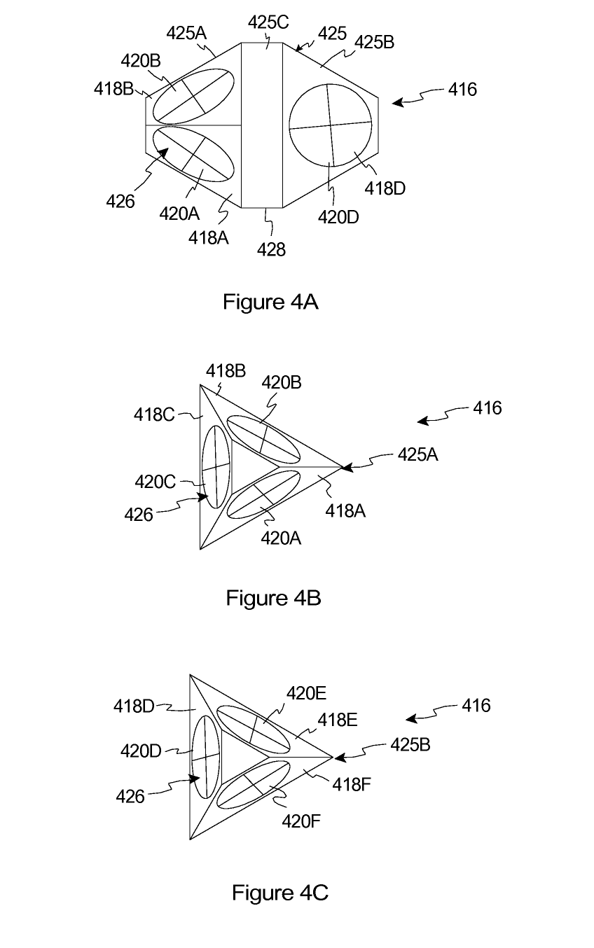

FIG. 4A is a side view, FIG. 4B is a left end view, and FIG. 4C is a right end view of still another embodiment of a target 416 that is somewhat similar to the target 316 described above and illustrated in FIGS. 3A-3C. In FIGS. 4A-4C, the target housing 425 is again shaped similar to two truncated tetrahedrons attached together with a spacer therebetween (which can house electronics of the target 416). More specifically, the target housing 425 includes (i) a first region 425A that is shaped similar to a truncated tetrahedron; (ii) a second region 425B that is shaped similar to a truncated tetrahedron; and (iii) a center region 425C that is positioned between and secures the first region 425A to the second region 425B. However, in FIGS. 4A-4C, the first region 425A is rotated relative to the second region 425B. In this embodiment, the tetrahedrons 425A, 425B are rotated approximately sixty degrees relative to each other. Alternatively, the tetrahedrons 425A, 425B can be rotated a different angle relative to each other.

In this embodiment, (i) the first region 425A includes a first target surface 418A, a second target surface 418B, and a third target surface 418C; (ii) the second region 425B includes a fourth target surface 418D, a fifth target surface 418E, and a sixth target surface 418F; and (iii) the center region 425C includes an engaging surface 428 that engages the object 12 (illustrated in FIG. 1A). Alternatively, for example, the engaging surface 428 can be at one of the tops of the first or second regions 425A, 425B. In this embodiment, each of the target surfaces 418A-418F is trapezoidal shaped and at an angle relative to the other target surfaces 418A-418F.

Again, in this embodiment, the photo detector assembly 426 detects the fan beams 22A, 22B as they are moved across the target 416. In FIGS. 4A-4C, the photo detector assembly 426 includes (i) a first detector 420A that is secured to and positioned on the first target surface 418A, (ii) a second detector 420B that is secured to and positioned on the second target surface 418B, (iii) a third detector 420C that is secured to and positioned on the third target surface 418C, (iv) a fourth detector 420D that is secured to and positioned on the fourth target surface 418D, (v) a fifth detector 420E that is secured to and positioned on the fifth target surface 418E, and (vi) a sixth detector 420F that is secured to and positioned on the sixth target surface 418F.

In this embodiment, the detectors 420A-420F are mounted on faces of the two truncated tetrahedron shaped regions 425A, 425B. With this design, the target 416 is sensitive to signals over a sphere, and the fan beams 22A, 22B from one of the transmitters 14 (illustrated in FIG. 1B) will always impinge upon three detectors 420A-420F during movement of the fan beams 22A, 22B over the target 416. In this embodiment, one or more of the detectors 420A-420F can be similar to the detectors 220A-220C described above and illustrated in FIGS. 2A-2C.

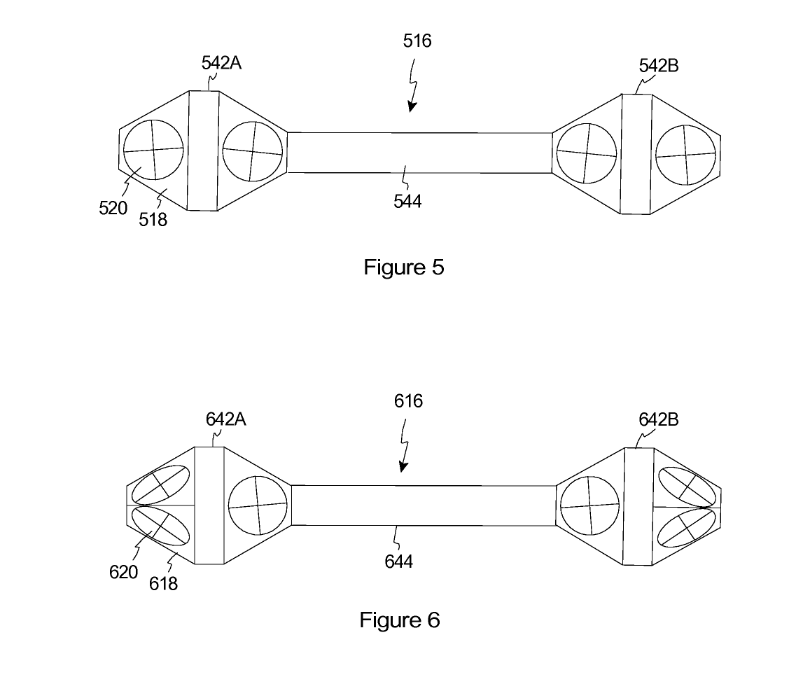

FIG. 5 is a side view of yet another embodiment of a target 516 that is a “vector bar” type target. In this embodiment, the target 516 includes a left target subassembly 542A, a right target subassembly 542B, and a separator bar 544 that extends between and fixedly secures the subassemblies 542A, 542B together at a fixed, known distance. In this embodiment, each subassembly 542A, 542B is substantially similar to the target 316 described above and illustrated in FIGS. 3A-3C. With this design, the target 516 illustrated in FIG. 5 includes twelve separate target surfaces 518 (six on each subassembly 542A, 542B, only two on each subassembly 542A, 542B are visible), and twelve separate detectors 520 (six on each subassembly 542A, 542B, only two on each subassembly 542A, 542B are visible). With this design, the target 516 can be attached to the object 12 (illustrated in FIG. 1A) on either end of the target subassembly 542A, 542B that functions as the engaging surface. Further, with this design, the separator bar 544 or another part of the target 516 can be fixedly attached to the object 12. In this embodiment, one or more of the detectors 520 can be similar to the detectors 220A-220C described above and illustrated in FIGS. 2A-2C. With this design, the target 516 is sensitive to signals over a sphere, and depending on the orientation of the target 516, the fan beams 22A, 22B from one of the transmitters (illustrated in FIG. 1B) will impinge upon anywhere from three to eight detectors 520 during movement of the fan beams 22A, 22B over the target 516. Providing two targets separated by a known distance provides redundancy and greater accuracy in position determination.

FIG. 6 is a side view of still another embodiment of a target 616 that is a “vector bar” type target. In this embodiment, the target 616 includes a left target subassembly 642A, a right target subassembly 642B, and a separator bar 644 that extends between and fixedly secures the subassemblies 642A, 642B together at a fixed, known distance. In this embodiment, each subassembly 642A, 642B is substantially similar to the target 416 described above and illustrated in FIGS. 4A-4C. With this design, the target 616 illustrated in FIG. 6 includes twelve separate target surfaces 618 (six on each subassembly 642A, 642B, only three on each subassembly 642A, 642B are visible), and twelve separate detectors 620 (six on each subassembly 642A, 642B, only three on each subassembly 642A, 642B are visible). With this design, the target 616 can be attached to the object 12 (illustrated in FIG. 1A) on either end of the target subassembly 642A, 642B that functions as the engaging surface. Further, with this design, the separator bar 644 or another part of the target 616 can be fixedly attached to the object 12. In this embodiment, one or more of the detectors 620 can be similar to the detectors 220A-220C described above and illustrated in FIGS. 2A-2C. With this design, the target 616 is sensitive to signals over a sphere, and the fan beams 22A, 22B from one of the transmitters 14 (illustrated in FIG. 1B) will always impinge upon at least three detectors 620 during movement of the fan beams 22A, 22B over the target 616.

It should be noted than any of the other targets disclosed herein can be attached to separator bar 544 or 644.

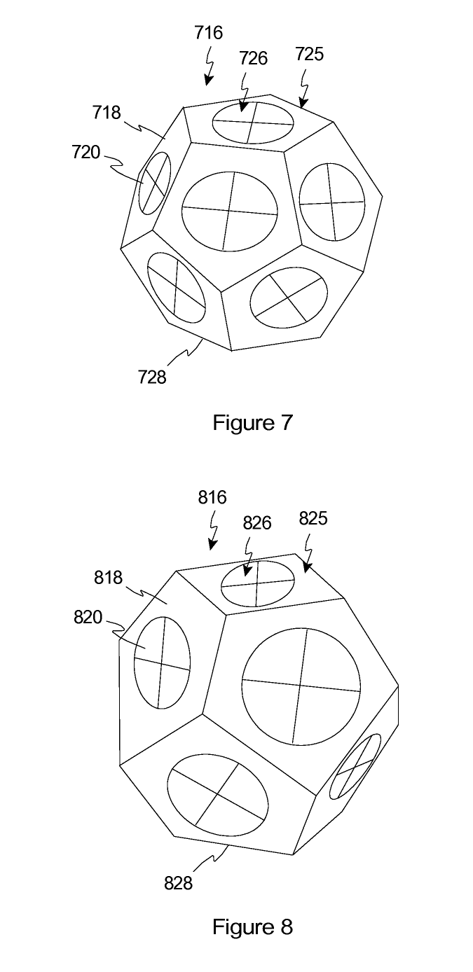

FIG. 7 is a perspective view of another embodiment of a target 716 having features of the present invention. In this embodiment, the target housing 725 is a dodecahedron (twelve sided), and includes eleven target surfaces 718 (only six are visible in FIG. 7) and one engaging surface 728 that can be mounted to the object 12 (illustrated in FIG. 1A). Again, in this embodiment, the target surfaces 718 are at an angle relative to the other target surface 718. Moreover, in this embodiment, the photo detector assembly 726 includes eleven separate detectors 720 (only six are visible in FIG. 7) that are mounted to the target surfaces 718. In this embodiment, one or more of the detectors 720 can be similar to the detectors 220A-220C described above and illustrated in FIGS. 2A-2C.

The advantage of the dodecahedron is that a larger number of detectors 720 will intercept the fan beams from a transmitter. This will provide greater measurement redundancy. Some of the detectors will also be more perpendicular to the fan beams 22A, 22B (illustrated in FIG. 1B) more of the time, so the detectors 720 should receive stronger signals.

FIG. 8 is a perspective view of another embodiment of a target 816 having features of the present invention. In this embodiment, the target housing 825 is a decahedron (ten sided), and includes nine target surfaces 818 (only five are visible in FIG. 8) and one engaging surface 828 that can be mounted to the object 12 (illustrated in FIG. 1A). Again, in this embodiment, the target surfaces 818 are at an angle relative to the other target surface 818. Moreover, in this embodiment, the photo detector assembly 826 includes nine separate detectors 820 (only five are visible in FIG. 8) that are mounted to the target surfaces 818. In this embodiment, one or more of the detectors 820 can be similar to the detectors 220A-220C described above and illustrated in FIGS. 2A-2C.

The dodecahedron (illustrated in FIG. 7) and decahedron (illustrated in FIG. 8) shown above are geometrically similar in that each has a flat top and bottom face, with two rings of faces there between, consisting of either five (the dodecahedron) target surfaces 718 or four (the decahedron) target surfaces 818. The two rings are clocked with respect to each other (by 360/10 and 360/8 degrees respectively) to increase the range of angles that are seen by the target surfaces 718, 818.

Another geometry is an eight sided polyhedron. In this embodiment, the target housing (not shown) would include seven target surfaces and one engaging surface. Further, the photo detector assembly 826 could include seven separate detectors that are mounted to the target surfaces. In this embodiment, the target housing would look somewhat similar to the embodiments illustrated in FIGS. 7 and 8, but each ring would only contain three target surfaces. This shape would look like two truncated tetrahedra, placed back to back and clocked 360/6 degrees with respect to each other. As long as the transmitters 14 (illustrated in FIG. 1A) are well distributed, or there are many transmitters 14, this configuration is also capable of providing a full 6-DOF measurement.

It should be noted that other multiple sided designs can be utilized.

The advantage of many of the shapes for the targets 16-816 provided herein, is that from all directions (neglecting the directions blocked by the mounting face), at least three target surfaces are always visible. With detectors on each target surface, this allows at least three points to be measured for each target 16-816. From the three points, and knowing their positions with respect to each other, one can calculate the full six degree of freedom location and orientation of the target 16-816 in space.

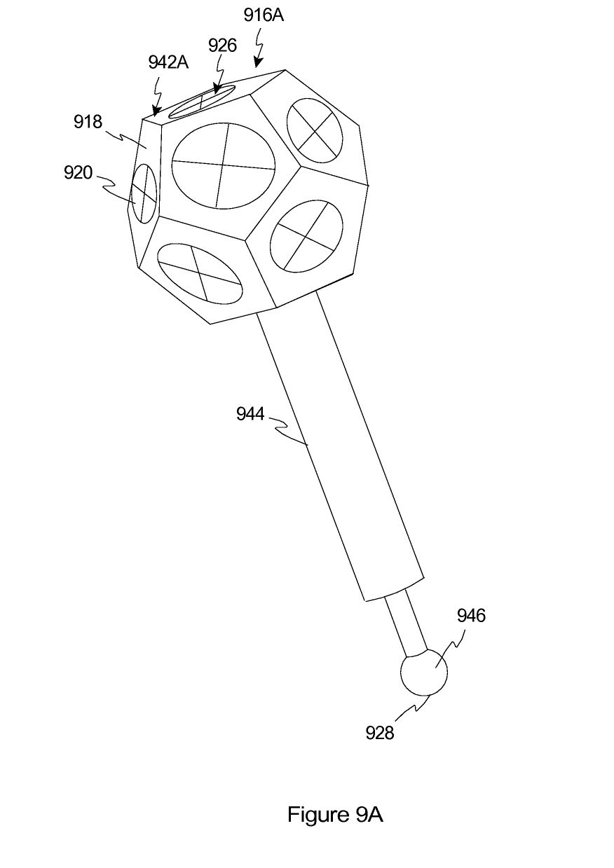

FIG. 9A is a perspective view of yet another embodiment of a target 916A having features of the present invention. In this embodiment, the target 916A is a scepter type design that includes a distal target subassembly 942A, and a cantilevering bar 944 that cantilevers away from the target subassembly 942A. In this embodiment, the target subassembly 942A is similar to the target 716 described above and illustrated in FIG. 7. With this design, the target subassembly 942A illustrated in FIG. 9 includes eleven separate target surfaces 918 (only six are visible), and the photo detector assembly 926 includes eleven separate detectors 920 (only six are visible). Alternatively, another one of the targets disclosed herein can be attached to the cantilevering bar 944.

In one non-exclusive embodiment, as illustrated in FIG. 9A, a proximal bar tip 946 of the bar 944 can be spherical shaped. With this design, the scepter target 916 can be manually positioned and held so that the bar tip 946 functions as an engaging surface 928 that selectively engages the object 12 (illustrated in FIG. 1A). In this design, the target 916A can be manually moved as a probe to selectively determine the position of one or more objects 12.

FIG. 9B is a perspective view of yet another embodiment of a target 916B having features of the present invention. In this embodiment, the target 916B is a scepter type design that is somewhat similar to the target 916A described above and illustrated in FIG. 9A. However, in this embodiment, the target 916B includes a proximal target subassembly 942B that is spaced apart from the distal target subassembly 942A along the cantilevering bar 944. In this embodiment, the proximal target subassembly 942B includes ten separate target surfaces 918 (only five are visible), and the photo detector assembly 926 includes ten separate detectors 920 (only five are visible). Alternatively, another one of the targets disclosed herein can be attached to the cantilevering bar 944.

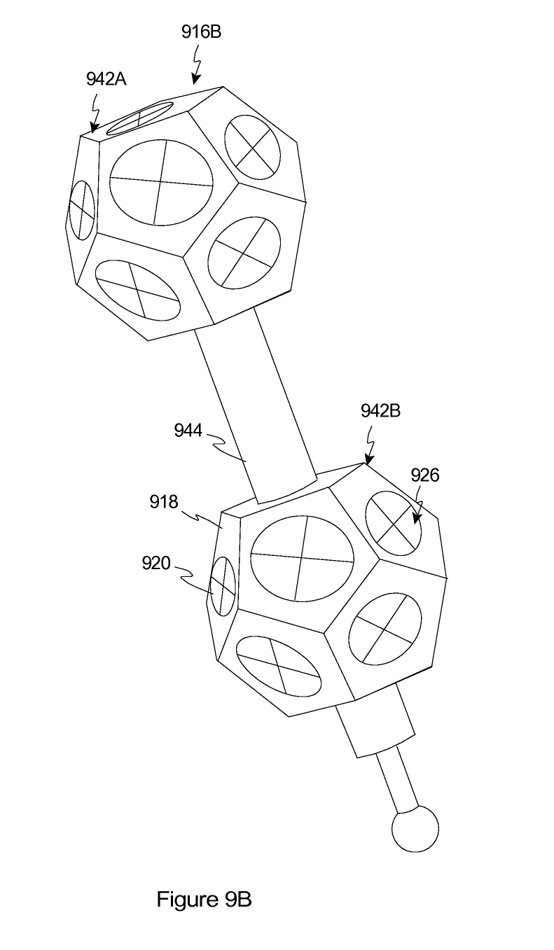

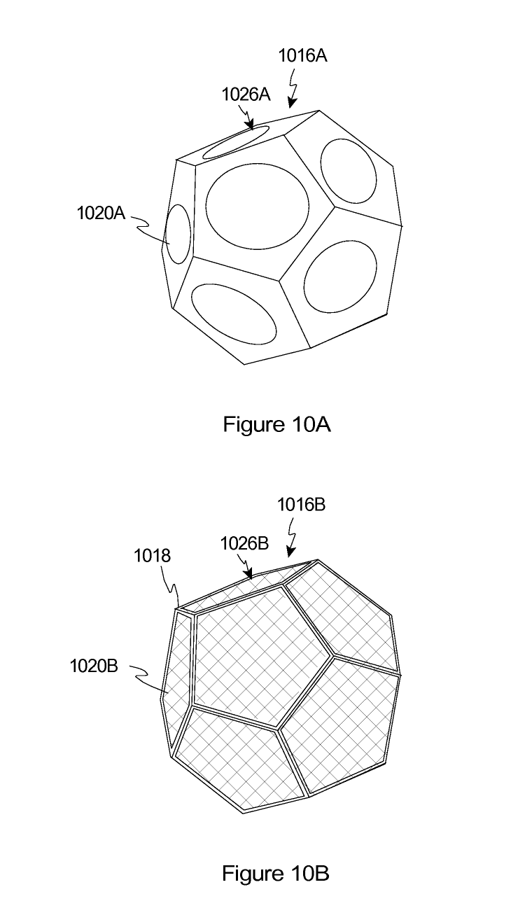

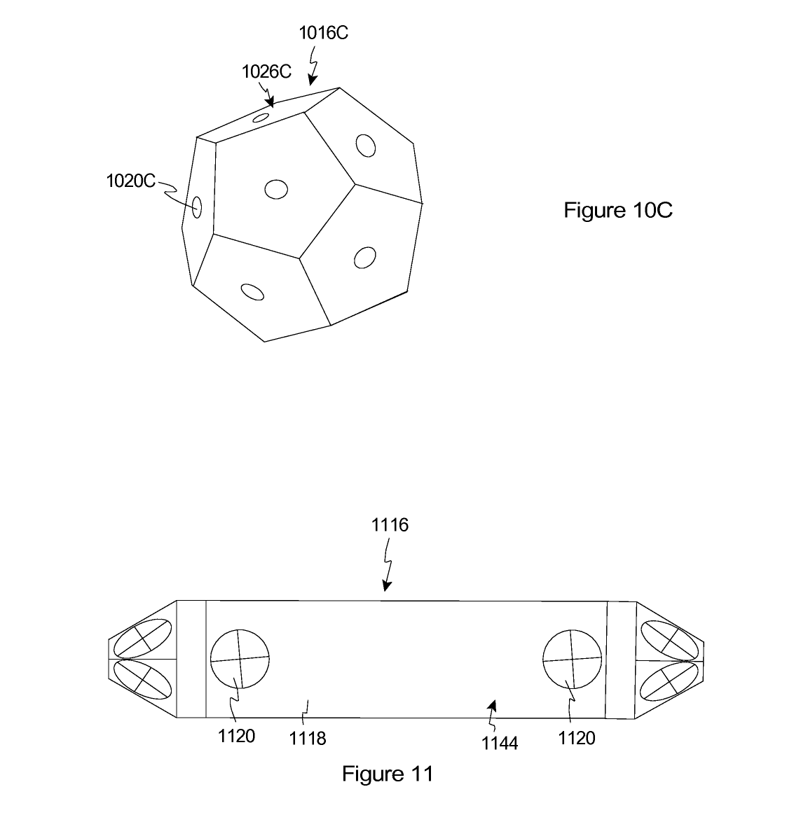

FIG. 10A illustrates a perspective view of another embodiment of a target 1016A having features of the present invention. In this embodiment, the target 1016A is similar to the design illustrated in FIG. 7 and described above. In this embodiment, the photo detector assembly 1026A includes eleven separate photosensors 1020A that each provides a separate signal to the control system 17 (illustrated in FIG. 1A). However, in this embodiment, each detector 1020A includes a flat, disk shaped, single cell photodetector. With this design, as the beams 22A, 22B (illustrated in FIG. 1B) impinge upon a detector 1020A, the control system 17 can analyze the signal from that detector 1020A to determine when each beam is centered on the detector 1020A. With the disk shaped detector 1020A, the signal is the strongest when each beam 22A, 22B (illustrated in FIG. 1B) is directed at its center because the area of the detector 1020A is greatest there. Thus, by monitoring when the signal peak occurs, the center can be determined, and the azimuth and elevation of that center relative to the transmitter 14 can be determined. It should be noted that the photodetectors 1020A illustrated in FIG. 10A can be used in any of the other targets disclosed herein.

FIG. 10B illustrates a perspective view of another embodiment of a target 1016B having features of the present invention. In this embodiment, the target 1016B is again somewhat similar to the design illustrated in FIG. 7 and described above. In this embodiment, the photo detector assembly 1026B includes eleven separate photodetectors 1020B. However, in this embodiment, each detector 1020B is a single cell detector having a flat shape that corresponds to the shape of the target surface 1018 for which it is attached. In one embodiment, each detector 1020B is approximately the same size as the respective target surface 1018. In this arrangement, the borders between the photodetectors 1020B are minimized to improve the response characteristics. Alternatively, each detector 1020B can be smaller that the size of the target surface 1018. It should be noted that the photo detectors 1020B disclosed in FIG. 10B can be used in any of the other targets disclosed herein.

In one embodiment, each of the detectors 1020B provides a separate signal to the control system 17 (illustrated in FIG. 1A) for analysis. With this design, as the beams 22A, 22B (illustrated in FIG. 1B) impinge upon a detector 1020B, the control system 17 can analyze the signal from that detector 1020B to determine when each beam is centered on the detector 1020B.

Alternatively, the signals from one or more (e.g. all) of the detectors 1020B can be lumped together and analyzed by the control system 17 to determine the center of the target 1016B.

FIG. 10C illustrates a perspective view of another embodiment of a target 1016C having features of the present invention. In this embodiment, the target 1016C is similar to the design illustrated in FIG. 7 and described above. In this embodiment, the photo detector assembly 1026C includes eleven separate, flat, photodetectors 1020C. However, in this embodiment, each detector 1020C is a relatively small disk shaped, single cell detector. It should be noted that the photo detectors 1020C illustrated in FIG. 10C can be used in any of the other targets disclosed herein.

With this design, as the beams 22A, 22B (illustrated in FIG. 1B) impinge upon a detector 1020C, the control system 17 can analyze the signal from that detector 1020C to determine when each beam is centered on the detector 1020C. With the disk shaped detector 1020C, the signal is the strongest when each beam 22A, 22B (illustrated in FIG. 1B) is directed at its center because the area of the detector 1020C is greatest there. Thus, by monitoring when the signal peak occurs the center can be determined, and the azimuth and elevation of that center relative to the transmitter 14 can be determined.

In this embodiment, each photosensor 1020C is deliberately made small. For this embodiment, the orientation of the photosensors 1020C can be deduced using signal analysis. In certain embodiment, a very narrow fan beam 22A, 22B combined with small photosensors 1020C may be desired to make signal processing easier.

Alternatively, the signals from one or more (e.g. all) of the detectors 1020C can be lumped together as single signal and analyzed by the control system 17 to determine the center of the target 1016C.

As provided herein, in certain embodiments, a target having a spherical shaped photosensor is desired because the signal will be the same regardless of the orientation of the target relative to the beams 22A, 22B. However, this type of photosensor is difficult and expensive to make. The present invention provides a very good approximation to the ideal spherical surface by utilizing a plurality of flat photosensors that are inexpensive and easily available, arranged in a geometrical array. Generally speaking, as the number of facets (target surfaces) increases, the overall shape more closely approximates a sphere, and can improve system accuracy. In certain embodiments, at least one of the target surfaces is partly or totally obscured to provide a mounting structure and conduit for electrical connections.

It should be noted that the shapes of targets disclosed herein are non-exclusive examples of possible designs, and that targets can be designed with greater or fewer target surfaces than disclosed herein.

FIG. 11 is a side view of still another embodiment of a target 1116 that is a “vector bar” type target that is somewhat similar to the design illustrated in FIG. 6 and described above. In this embodiment however, the separator bar 1144 has a triangular shaped cross-section, and two of the detectors 1120 are positioned directly on each surface 1118 of the separator bar 1144. It should be noted that the other designs of the target provided herein can be designed to have more than one detector 1120 on a given target surface.

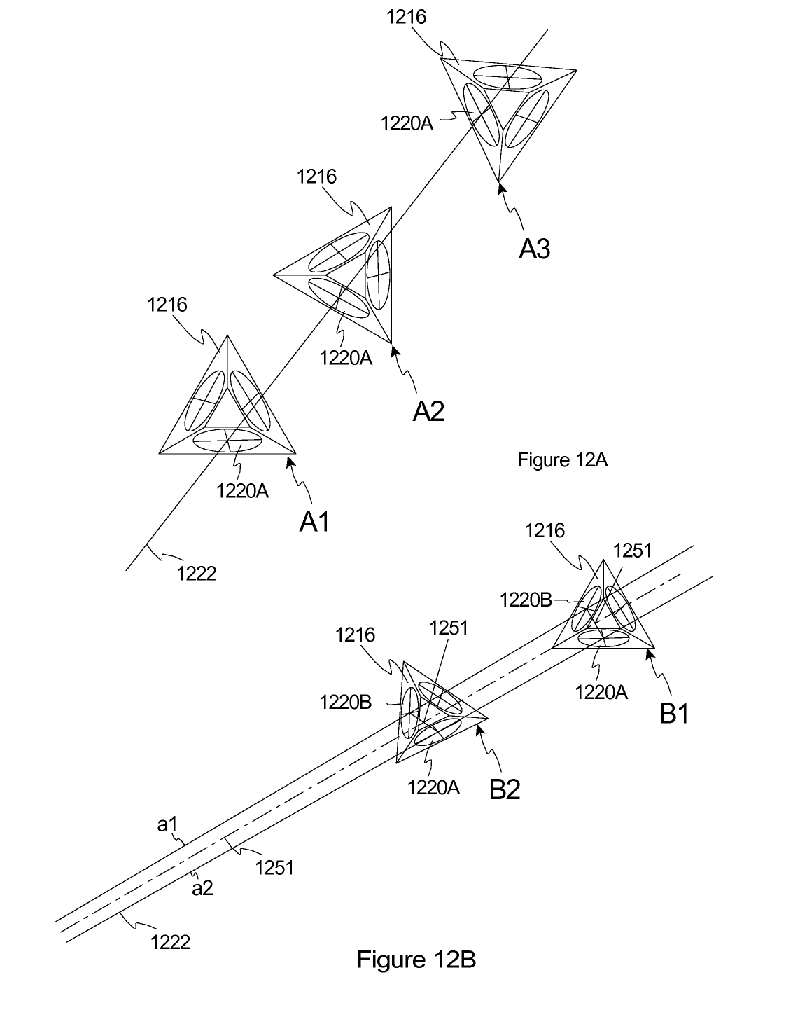

Understanding the conditions required for accurately locating a target and its attachment point to an object are essential for understanding the embodiments. FIG. 12A illustrates a tetrahedron shaped target 1216, such as described above and illustrated in FIGS. 2A and 2B. In this illustration, a center of the first detector 1220A is intercepted by a fan beam 1222. With information from the first signal from the first detector 1220A, the azimuth and elevation of the first detector 1220A can be determined. In FIG. 12A, the target 1216 is shown in three orientations A1, A2 and A3, where the fan beam 1222 only intercepts the single, first detector 1220A. Timing information from the fan beams 1222 or the azimuthal strobe pulse 24 (illustrated in FIG. 1C) is unable to distinguish among the different orientations shown in FIG. 12A. Thus the azimuth and elevation of a single detector 1220A is not enough information to determine the orientation of the target 1216.

FIG. 12B illustrates two orientations B1 and B2 of the target 1216 where a single fan beam 1222 intercepts the centers of the first detector 1220A and the center of the second detector 1220B. In this Figure, the fan beam 1222 is sequentially at locations a1 and a2. The center of rotation of the fan beam 1222 is to the left of the FIG. 12B, so fan beams a1 and a2 diverge as they travel from locational to location a2. Again, in this example, the orientation of the target 1216 can not be determined from the elevation and azimuth of two detectors 1220A, 1220B. However, some constraints on the distance of the target 1216 can be imposed. When the detectors 1220A, 1220B are in the position and orientation B1, the first detector 1220A and the second detector 1220B are substantially symmetrically oriented relative to fan beam 1222 at locations a1 and a2. At this time a line 1249 connecting the centers of the two detectors 1220A, 1220B is perpendicular to a line 1251 bisecting the angle between fan beam 1222 at location a1 and a2. The length of the line 1249 is determined from the geometry of the target 1216. As will be shown, this situation puts an upper limit on the distance of the target 1216 from the transmitter 14 (illustrated in FIG. 1A).

For the detector position and orientation B2, the fan beam 1222 at locational intercepts the center of the second detector 1220B while fan beam 1222 at location a2 intercepts the center of the first detector 1220A at a glancing angle, so little light is detected. For example, if the target 1216 were rotated any further counter clockwise about an axis emerging normal to the plane of the figure, no light from the fan beam 1222 would impinge on the first detector 1220A. Additionally, given the assumption that the fan beam 1222 at locations a1 and a2 intercept the centers of the detectors 1220A, 1220B, if the target 1216 were any closer to the transmitter 14, the first detector 1220A would no longer receive any light. Thus, location B2 represents a lower limit on the distance of the target 1216 from the transmitter 14.

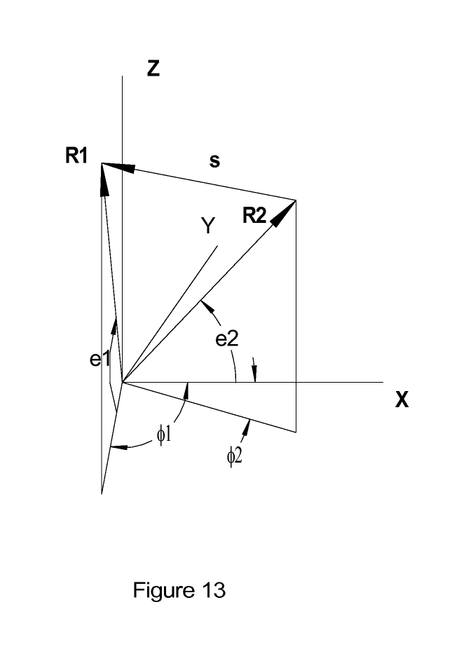

FIG. 13 illustrates vectors R1 and R2 representing rays of a fan beam 1222 (illustrated in FIG. 12B) hitting the centers of the first detector 1220A (illustrated in FIG. 12B), and the second detector 1220B (illustrated in FIG. 12B). In the x, y, z coordinate system of FIG. 1D the vectors can be written as

R1=r1(cos e₁ cos φ₁\hat{x}+cos e₁ sin φ₁ŷ+sin e₁\hat{z})

R2=r2(cos e₂ cos φ₂\hat{x}+cos e₂ sin φ₂ŷ+sin e₂\hat{z}) Equation (1)

Where r1, r2 are the magnitudes of the vectors R1, R2, φ₁ and φ₂ are the azimuthal angles, e₁, e₂ are the elevation angles, and \hat{x}, ŷ, \hat{z} are unit vectors along the axes.

The line 1249 (“s”) between the first and second detectors 1220A, 1220B is also shown as a vector, leading to the relation:

s=R1−R2. Equation (2)

The magnitude of s is given by s=|s.s|^{1/2}, where “.” is the dot product, so we have:

s=[r1²+r2²−2r1r2(cos e₁ cos e₂ cos(φ₁−φ₂)+sin e₁ sin e₂)]^{1/2} Eq. (3)

Recall that the elevation angles are defined by:

e₁=arcsin(elevation1/r1)

e₂=arcsin(elevation2/r2) Equation (4)

The elevations, the azimuthal angles and the distance s between detector centers are assumed known. Therefore the single equation 3 has two unknowns r1 and r2, so there is no unique solution. However if the orientation and distance of the target are the same as condition B2 in FIG. 12B, the distances r1 and r2 are equal, r1=r2≡r, and Equation 3 can be solved for r:

s=[2r²−2r²(cos e₁ cos e₂ cos(φ₁−φ₂)+sin e₁ sin e₂)]^{1/2} Equation (5)

Note that:

$$sin e = elevation / r \\ cos e = \sqrt{1 - {( \frac{elevation}{r} )}^{2}} \qquad Equation ( 6 )$$

Thus an upper limit to the distance of the target from the transmitter can be determined when a single transmitter illuminates two detectors. However, the orientation of the target remains undetermined. The target can rotate freely about the line s without affecting Eq. 3.

If three faces of a target are illuminated by fan beams from a transmitter or several transmitters, the target's location and orientation can be completely determined. In this case the fan beams illuminating the centers of the three detectors define three vectors:

R1=r1(cos e₁ cos φ₁\hat{x}+cos e₁ sin φ₁ŷ+sin e₁\hat{z})

R2=r2(cos e₂ cos φ₂\hat{x}+cos e₂ sin φ₂ŷ+sin e₂\hat{z})

R3×r3(cos e₃ cos φ₃\hat{x}+cos e₃ sin φ₃ŷ+sin e₃\hat{z}) Equation (7)

The centers of the detectors are separated by three known distances s12, s13, s23, which satisfy three relations similar to Eq. 3.

s12=[r1²+r2²−2r1r2(cos e₁ cos e₂ cos(φ₁−φ₂)+sin e₁ sin e₂)]^{1/2}

s13=[r1²+r3²−2r1r3(cos e₁ cos e₃ cos(φ₁−φ₃)+sin e₁ sin e₃)]^{1/2}

s23=[r2²+r3²−2r2r3(cos e₂ cos e₃ cos(φ₂−φ₃)+sin e₂ sin e₃)]^{1/2} (8)

Assuming the azimuths and elevations are known, there are now three equations and three unknowns, r1, r2 and r3, so the distance and orientation of the target can be determined.

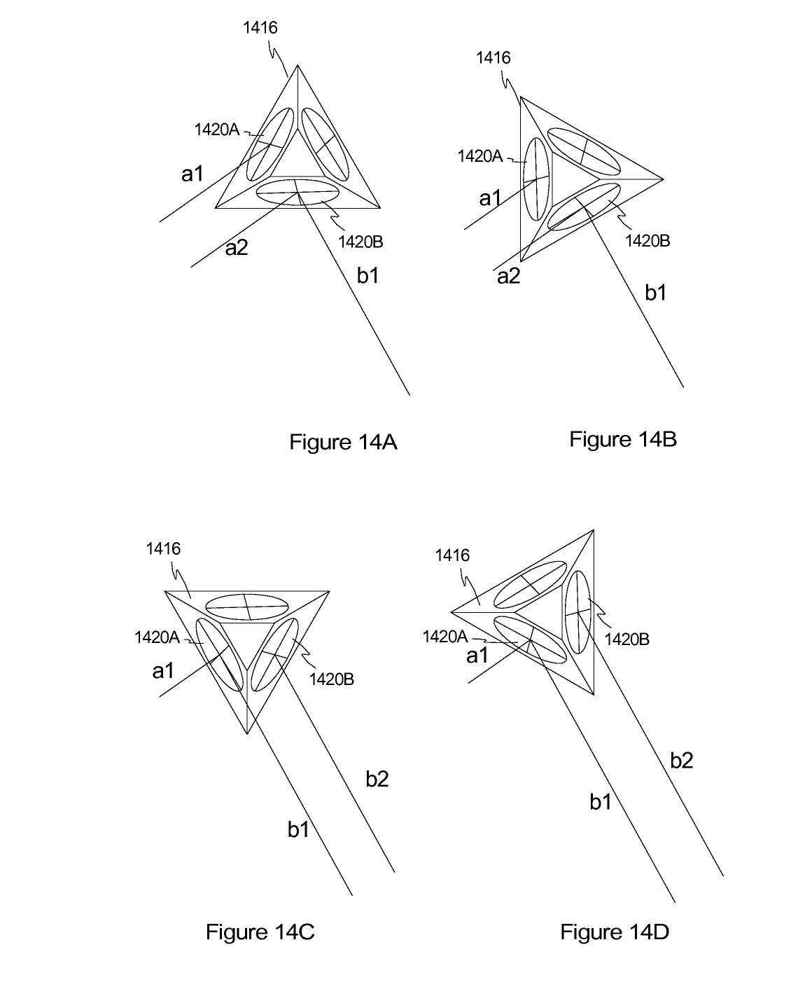

FIGS. 14A-14D illustrate situations where the first and second detectors 1420A, 1420B of a target 1416 are visible to two transmitters (not shown) producing fan beams a and b. In this example, the fan beams are approximately at right angles to one another. In FIG. 14A the detectors 1420A, 1420B intercept fan beam a at locations a1 and a2, and the second detector 1420B additionally intercepts fan beam b1. In FIG. 14B, the target 1416 orientation is such that the second detector 1420B barely intercepts fan beam a2, but still intercepts fan beam b1. In FIG. 14C, the first detector 1420A intercepts fan beam a1 and also barely intercepts fan beam b1 while the second detector 1420B intercepts only fan beam b2. In FIG. 13D, the first detector 1420A intercepts fan beams a1 and b1, while the second detector 1420B intercepts fan beam b2. None of the fan beams intercept the detectors 1420A, 1420B at grazing angles, where measurement accuracy may be reduced. Thus, many combinations of detectors and fan beams are possible. This in turn provides some redundancy which can improve measurement accuracy.

In these figures, the tetrahedron shaped target 1416 is shown in a top view, and changes in orientation are represented by rotations about an axis normal to the plane of the figure, for simplicity. However the conclusions presented here, and Equations 1-8, are applicable to different target orientations in general.

Equation 8 demonstrate that if a fan beam intercepts, or multiple fan beams intercept, the centers of three detectors on a target, the position and orientation of the target is determined, and the location of the attachment of the target to the object is also determined. However, the numerical accuracy of this determination may be inadequate for some applications. The quantities s12 etc. in Equation 8 are typically several orders of magnitude smaller than the distances r12 etc. In addition the Equations 4 and 6 introduce a non-linear dependence on the unknown distances r12 etc. Both effects will tend to increase the sensitivity of the results to unavoidable measurement errors associated with the azimuth and elevation.

Improved accuracy should be obtainable with detectors of the “vector bar” type (illustrated in FIGS. 5, 6, and 10). Assuming the two target assemblies comprising the “vector bar” type each intercept the fan beams on three detectors, the location of each subassembly is determined, as described using Equation 8. In addition, the known distance separating the two subassemblies will serve as an additional constraint to reduce the effects of measurement errors on the two subassembly locations. This distance is typically substantially larger than the separation of detectors within a single subassembly. With its inclusion, determination of the locations of the two detector subassemblies, and the object, should be improved. Additional accuracy can be obtained by combining these results with triangulation measurements using multiple transmitters.

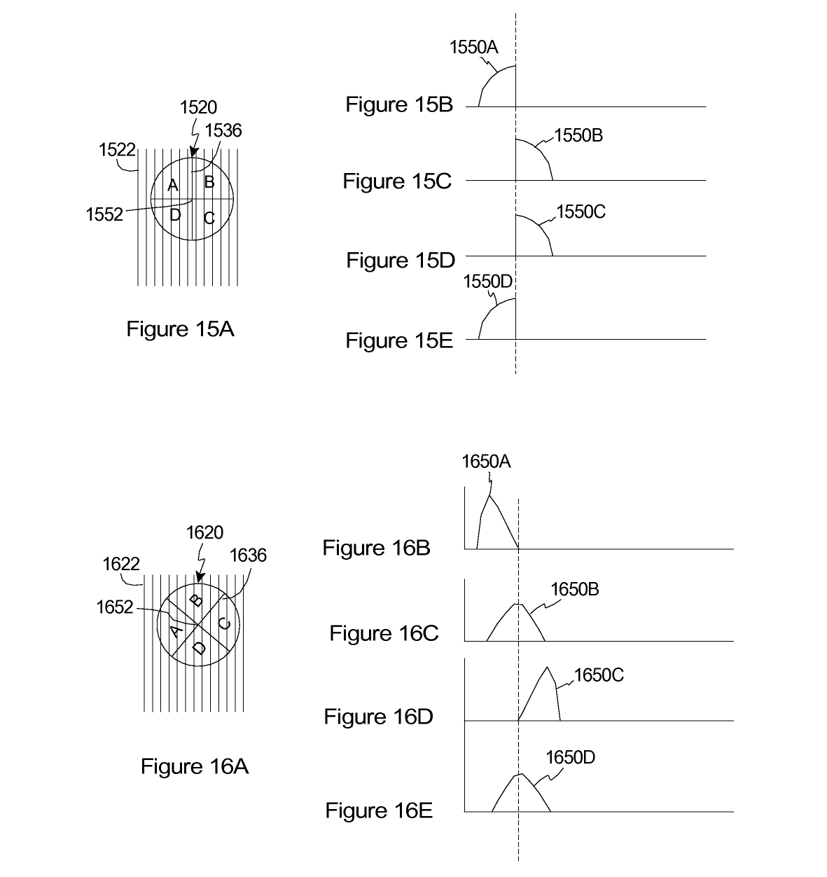

As provided herein, in certain embodiments, the fan beams 22A, 22B will extend beyond the detector cells of the detectors. FIG. 15A is a simplified illustration of one of the fan beams 1522 positioned at consecutive time intervals (illustrated as sequential lines) as it moves across one detector 1520. In this example, the fan beam 1522 is moving from left to right over the detector 1520. In FIG. 15A, (i) the first detector cell is labeled with “A”; (ii) the second detector cell is labeled with “B”; (iii) the third detector cell is labeled with “C”; and (iv) the fourth detector cell is labeled with “D. It should be noted that in FIG. 15A, the fan beam 1522 is aligned with the vertical portion of the “+” divider 1536.

FIG. 15B is a graph that illustrates a first detector cell signal 1550A for the first detector cell “A” as the fan beam 1522 is moved left to right over the detector 1520; FIG. 15C is a graph that illustrates a second detector cell signal 1550B for the second detector cell “B” as the fan beam 1522 is moved left to right over the detector 1520; FIG. 15D is a graph that illustrates a third detector cell signal 1550C for the third detector cell “C” as the fan beam 1522 is moved left to right over the detector 1520; and FIG. 15E is a graph that illustrates a fourth detector cell signal 1550D for the fourth detector cell “D” as the fan beam 1522 is moved left to right over the detector 1520.

In certain embodiments, each of the detector signals 1550A-1550D is an analog signal, and each detector cell provides an independent detector signal 1550A-1550D. Further, in certain embodiments, the control system 17 (illustrated in FIG. 1A) individually monitors the four detector cell signals 1550A-1550D for each detector 1520 to determine the location of each detector 1520. In certain embodiments, the control system 17 analyzes the four detector cell signals 1550A-1550D for each detector 1520 to determine a center location 1552 (illustrated in FIG. 15A) of each detector 1520.

In FIGS. 15B-15E, the vertical dashed line represents the time when the center of the fan beam 1522 sweeps over the center 1552 of the quad detector 1520. In the orientation of the detector 1520 relative to the fan beam 1522 illustrated in FIG. 15A, all of the detector cell signals 1550A-1550D (as illustrated in FIGS. 15B-15E) have a value of zero when the fan beam 1522 sweeps over the center 1552 of the quad detector 1520. Thus, in this unique situation, it is very easy to determine when the fan beam 1522 sweeps over the center 1552 of the quad detector 1520. Stated in another fashion, the relationship between the detector signals 1550A-1550D, and the “centering” time are obvious in this unique situation.

FIG. 16A is a simplified illustration of one of the fan beams 1622 positioned at consecutive time intervals (illustrated as sequential lines) as it moves across one detector 1620. In this example, the fan beam 1622 is moving from left to right over the detector 1620. In FIG. 16A, (i) the first detector cell is labeled with “A”; (ii) the second detector cell is labeled with “B”; (iii) the third detector cell is labeled with “C”; and (iv) the fourth detector cell is labeled with “D. It should be noted that in FIG. 16A, the fan beam 1622 is at an angle with the vertical portion of the “+” divider 1636. This is the more general case where the quadrant gaps 1636 are at some angle to the fan beam 1622.

FIG. 16B is a graph that illustrates a first detector cell signal 1650A for the first detector cell “A” as the fan beam 1622 is moved left to right over the detector 1620; FIG. 16C is a graph that illustrates a second detector cell signal 1650B for the second detector cell “B” as the fan beam 1622 is moved left to right over the detector 1620; FIG. 16D is a graph that illustrates a third detector cell signal 1650C for the third detector cell “C” as the fan beam 1622 is moved left to right over the detector 1620; and FIG. 16E is a graph that illustrates a fourth detector cell signal 1650D for the fourth detector cell “D” as the fan beam 1622 is moved left to right over the detector 1620.

In this embodiment, each of the detector cell signals 1650A-1650D is an analog signal, and each detector cell provides an independent detector signal 1650A-1650D. Further, the control system 17 (illustrated in FIG. 1A) individually monitors the four detector signals 1650A-1650D for each detector 1620 to determine the location of each detector 1620. Stated in another fashion, the control system 17 analyzes the detector cell signals 1650A-16050D for each detector 1620 to determine a center location 1652 (illustrated in FIG. 16A) of each detector 1620.

In FIGS. 16B-16E, the vertical dashed line represents the time when the center of the fan beam 1622 sweeps over the center 1652 of the quad detector 1620. In the orientation of the detector 1620 relative to the fan beam 1622 illustrated in FIG. 16A, (i) the A and C detector signals 1650A, 1650C (as illustrated in FIGS. 15B and 15D) have a value of zero when the fan beam 1622 sweeps over the center 1652 of the quad detector 1620; and (ii) the B and D detector signals 1650B, 1650D (as illustrated in FIGS. 15C and 15E) have a non-zero value when the fan beam 1622 sweeps over the center 1652 of the quad detector 1620. In this case, the relation between the “centering” time and the detector cell signals 1650A-1650D is more complicated. However, the pattern is pretty clear. The A and C detector cell signals 1650A, 1650C, and the B and D detector cell signals 1650B, 1650D are mirror images of one another about the “centering” time.

As provided herein, in certain embodiments, the four detector cell signals for each detector can be analyzed by the control system to determine the center of the respective detector. For example, the detector cell signals can be combined in a number of different fashions so that a null (or zero) occurs as the fan beam passes the center of the quad detector.

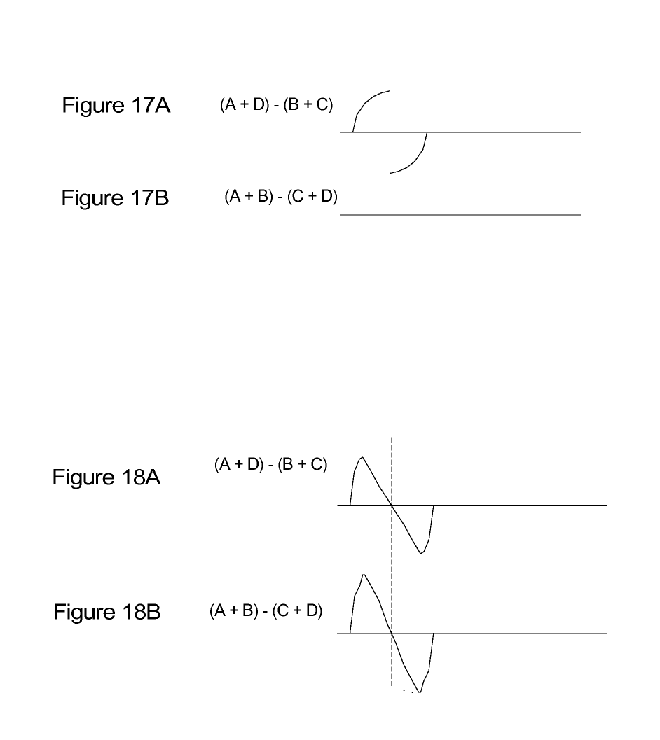

FIG. 17A illustrates the situation from FIG. 15A, when the control system 17 combines the A and D signals (A signal+D signal) and subtracts the combination of the B and C signals (B signal+C signal). In FIG. 17A, the vertical dashed line again represents the time when the fan beam 1522 (illustrated in FIG. 15A) sweeps over the center 1552 (illustrated in FIG. 15A) of the quad detector 1520 (illustrated in FIG. 15A). In this situation, ((A signal+D signal)−(B signal+C signal)), the control system 17 can identify the center 1552 of the detector 1520 because this is where the null occurs.

FIG. 17B illustrates the situation from FIG. 15A, when the control system 17 combines the A and B signals (A signal+B signal) and subtracts the combination of the C and D signals (C signal+D signal). In FIG. 17B, the vertical dashed line again represents the time when the fan beam 1522 (illustrated in FIG. 15A) sweeps over the center 1552 (illustrated in FIG. 15A) of the quad detector 1520 (illustrated in FIG. 15A). In this situation, ((A signal+B signal)−(C signal+D signal)), the control system 17 can not identify the center 1552 of the detector 1520 because this combination cancels each other because the divider 1536 is aligned with the fan beam 1522.

FIG. 18A illustrates the situation from FIG. 16A, when the control system 17 combines the A and D signals (A signal+D signal) and subtracts the combination of the B and C signals (B signal+C signal). In FIG. 18A, the vertical dashed line again represents the time when the fan beam 1622 (illustrated in FIG. 16A) sweeps over the center 1652 (illustrated in FIG. 16A) of the quad detector 1620 (illustrated in FIG. 16A). In this situation, ((A signal+D signal)−(B signal+C signal)), the control system 17 can identify the center 1652 of the detector 1620 because this is where the null occurs.

FIG. 18B illustrates the situation from FIG. 16A, when the control system 17 combines the A and B signals (A signal+B signal) and subtracts the combination of the C and D signals (C signal+D signal). In FIG. 18B, the vertical dashed line again represents the time when the fan beam 1622 (illustrated in FIG. 16A) sweeps over the center 1652 (illustrated in FIG. 16A) of the quad detector 1620 (illustrated in FIG. 16A). In this situation, ((A signal+B signal)−(C signal+D signal)), the control system 17 can again identify the center 1652 of the detector 1620 because this is where the null occurs.

It should be noted that the combination illustrated in FIGS. 18A, 18B is the more common combination because the fan beam 1622 is at an angle relative to the divider 1636. In this more common case, both signal combinations give a null signal at the “centering” time.

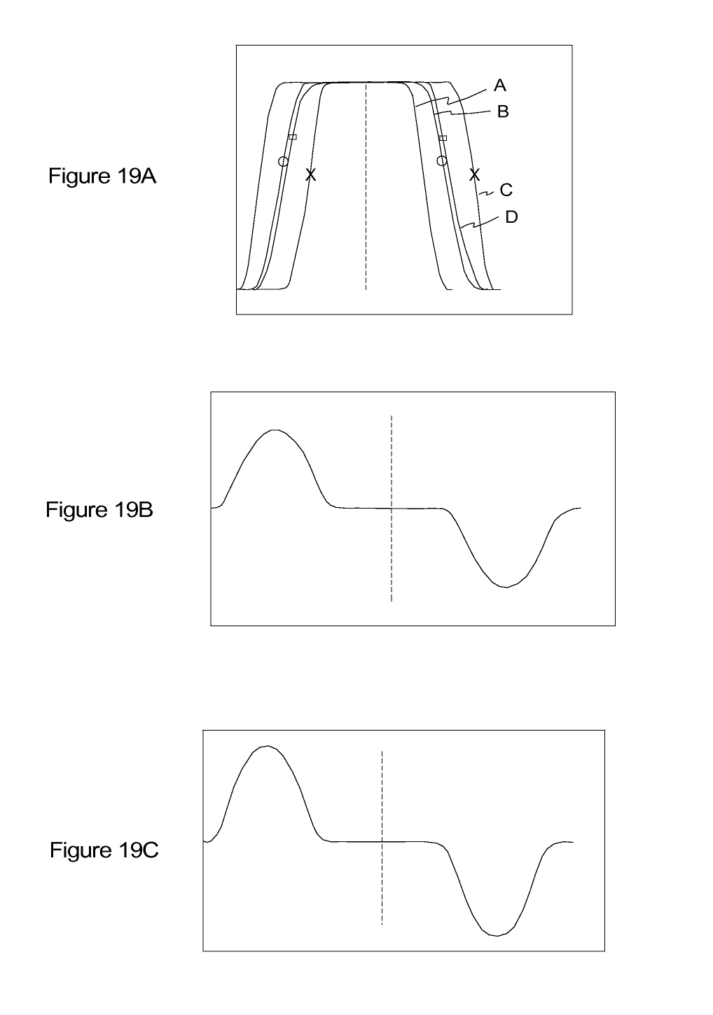

The signals shown in FIGS. 15-18 represent conditions where the width of the fan beam in the azimuthal direction is small compared to the width of a detector cell. When the detector is far from a transmitter, the fan beam may be wider than a detector cell in the azimuthal direction. In that case the signals resemble those shown in FIGS. 19A-19C. FIG. 19A illustrates the cell signals from the four detector cells A, B, C and D, where the detector is oriented as in FIG. 16A. FIG. 19B illustrates the signal combination (A+D)-(B+C), and FIG. 19C illustrates the signal combination (A+B)-(C+D). The dashed lines indicate the time at which the center of the fan beam sweeps across the center of the detector. In this example, instead of a null point, the graph shows a finite period when the combined signals are nulled out. The fan beam intercepts the center of the detector midway between the two peaks.

In FIGS. 15-19, it is assumed that the detector cells have equal areas and equal light sensitivity, or that the control system 17 compensates for any differences in detector cell size or gain. Without this provision a null condition in general would not be possible.

Additionally, it should be noted that one or more of the detectors can also detect a timing pulse from the fan beam source, which provides a calibration of the fan beam direction. The timing pulse can be detected from the signal A+B+C+D. If the timing pulse occurs during passage of the fan beam, it may be difficult to separate the two signals. The probe pulse signal is typically much weaker than the fan beam signal, so the relatively large sensitive area of the quad cell provides some advantage.

Moreover, in certain embodiments, since the fan beam may hit a detector at a relatively large angle to normal incidence, an antireflection coating may be utilized on each detector.

The detector signal intensity depends on the transmitter intensity, the distance of the detector from the transmitter and the orientation of the detector face to the fan beam. The signal is strongest when the fan beam is normally incident on the detector. The determination of the azimuth and elevation is also most accurate at normal incidence. The relative strength of signals from detectors on the same target can thus be related roughly to the accuracy of azimuth and elevation determination by each detector. This information can be used in combining the information from detectors to determine the target position and orientation, by weighting information from detectors with stronger signals more heavily.

The targets disclosed herein allow more precise position determination as well as the ability to determine orientation in space to obtain all six coordinates of the detector.

The unique detectors provided herein also eliminate a lot of calculations and compensations needed to figure out the position of the current detector due to the asymmetries and configuration of the detectors.

The present invention uses a simple quad cell detector concept and a geometry that ensures enough detectors are always visible to produce an unambiguous six degree of freedom position and orientation measurement.

Next, explanations will be made with respect to a structure manufacturing system that can utilize the measuring apparatus 100 (large metrology system) described hereinabove.

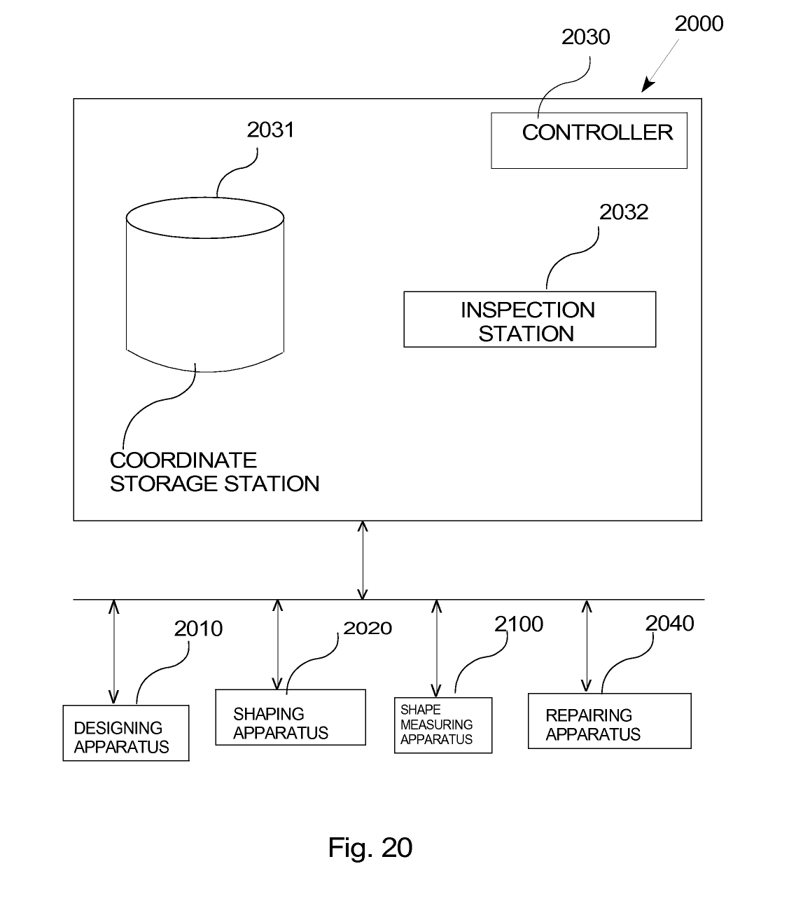

More specifically, FIG. 20 is a block diagram of one embodiment of a structure manufacturing system 2000. The structure manufacturing system 2000 can be used for producing at least a structure (e.g. an object) from at least one material. The structure can be any kind of part or assembly, such as part of a ship, a part of an airplane, or another kind of part.

In one embodiment, the structure manufacturing system 2000 includes (i) a profile measuring apparatus 2100 (e.g. the metrology system 100 as described herein above); (ii) a designing apparatus 2010; (iii) a shaping apparatus 2020, (iv) a controller 2030 (inspection apparatus); and (v) a repairing apparatus 2040. The controller 2030 includes a coordinate storage section 2031 and an inspection section 2032.

The designing apparatus 2010 creates design information with respect to the shape of a structure and sends the created design information to the shaping apparatus 2020. Further, the designing apparatus 2010 causes the coordinate storage section 2031 of the controller 2030 to store the created design information. The design information includes information indicating the coordinates of each position of the structure.

The shaping apparatus 2020 produces the structure based on the design information inputted from the designing apparatus 2010. The shaping process by the shaping apparatus 2020 includes such as casting, forging, cutting, and the like. The profile measuring apparatus 2100 measures the coordinates of the produced structure (measuring object) and sends the information indicating the measured coordinates (shape information) to the controller 2030.

The coordinate storage section 2031 of the controller 2030 stores the design information. The inspection section 2032 of the controller 2030 reads out the design information from the coordinate storage section 2031. The inspection section 2032 compares the information indicating the coordinates (shape information) received from the profile measuring apparatus 2000 with the design information read out from the coordinate storage section 2031. Based on the comparison result, the inspection section 2032 determines whether or not the structure is shaped in accordance with the design information. In other words, the inspection section 2032 determines whether or not the produced structure is defective. When the structure is not shaped in accordance with the design information, then the inspection section 2032 determines whether or not the structure is repairable. If repairable, then the inspection section 2032 calculates the defective portions and repairing amount based on the comparison result, and sends the information indicating the defective portions and the information indicating the repairing amount to the repairing apparatus 2040.

The repairing apparatus 2040 performs processing of the defective portions of the structure based on the information indicating the defective portions and the information indicating the repairing amount received from the controller 630.

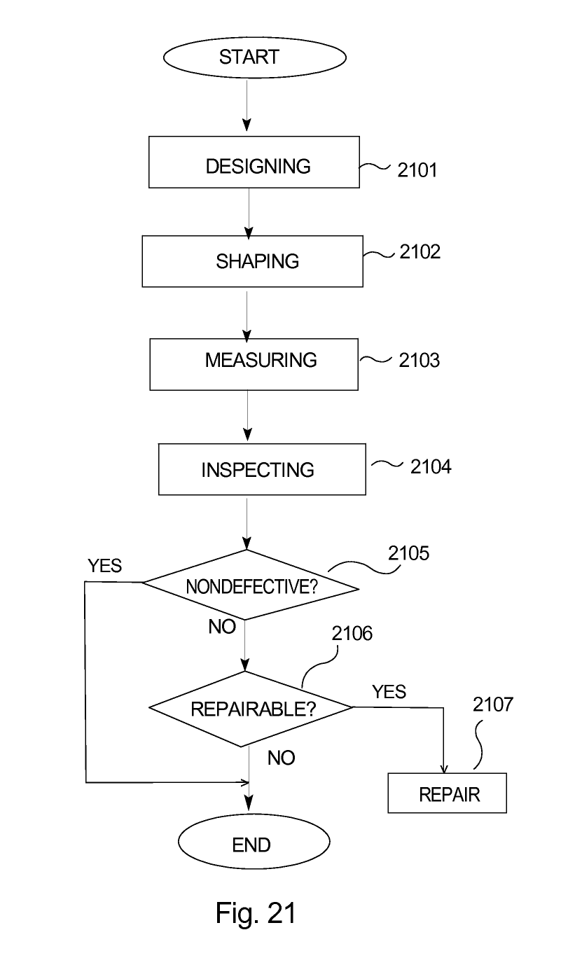

FIG. 21 is a flowchart showing a processing flow of the structure manufacturing system 2000. With respect to the structure manufacturing system 2000, first, the designing apparatus 2010 creates design information with respect to the shape of a structure (step 2101). Next, the shaping apparatus 2020 produces the structure based on the design information (step 2102). Then, the profile measuring apparatus 2100 measures the produced structure to obtain the shape information thereof (step 2103). Then, the inspection section 2032 of the controller 2030 inspects whether or not the structure is produced truly in accordance with the design information by comparing the shape information obtained from the profile measuring apparatus 2100 with the design information (step 2104).

Then, the inspection portion 2032 of the controller 2030 determines whether or not the produced structure is nondefective (step 2105). When the inspection section 2032 has determined the produced structure to be nondefective (“YES” at step 2105), then the structure manufacturing system 2000 ends the process. On the other hand, when the inspection section 2032 has determined the produced structure to be defective (“NO” at step 2105), then it determines whether or not the produced structure is repairable (step 2106).

When the inspection portion 2032 has determined the produced structure to be repairable (“YES” at step 2106), then the repair apparatus 2040 carries out a reprocessing process on the structure (step 2107), and the structure manufacturing system 2000 returns the process to step 2103. When the inspection portion 2032 has determined the produced structure to be unrepairable (“NO” at step 2106), then the structure manufacturing system 2000 ends the process. With that, the structure manufacturing system 2000 finishes the whole process shown by the flowchart of FIG. 21.

With respect to the structure manufacturing system 2000 of the embodiment, because the profile measuring apparatus 2100 in the embodiment can correctly measure the coordinates of the structure, it is possible to determine whether or not the produced structure is defective. Further, when the structure is defective, the structure manufacturing system 2000 can carry out a reprocessing process on the structure to repair the same.

Further, the repairing process carried out by the repairing apparatus 2040 in the embodiment may be replaced such as to let the shaping apparatus 2020 carry out the shaping process over again. In such a case, when the inspection section 2032 of the controller 2030 has determined the structure to be repairable, then the shaping apparatus 2020 carries out the shaping process (forging, cutting, and the like) over again. In particular for example, the shaping apparatus 2020 carries out a cutting process on the portions of the structure which should have undergone cutting but have not. By virtue of this, it becomes possible for the structure manufacturing system 2000 to produce the structure correctly.

In the above embodiment, the structure manufacturing system 2000 includes the profile measuring apparatus 2100, the designing apparatus 2010, the shaping apparatus 2020, the controller 2030 (inspection apparatus), and the repairing apparatus 2040. However, present teaching is not limited to this configuration. For example, a structure manufacturing system 2000 in accordance with the present can be used for assembling the structure and/or assembling multiple structures.

It is to be understood that invention disclosed herein are merely illustrative of the presently preferred embodiments of the invention and that no limitations are intended to the details of construction or design herein shown other than as described in the appended claims.

What is claimed is:

1. A target for a metrology system that monitors an object, the metrology system including a transmitter that generates a moving beam, the target comprising:
a target housing including a first target surface, and a second target surface that is at an angle relative to the first target surface; and
a photo detector assembly including a first detector secured to the first target surface and a second detector secured to the second target surface, the first detector generating a first signal that is used to identify when the beam impinges on the first detector, and the second detector generating a second signal that is used to identify when the beam impinges on the second detector.

2. The target of claim 1 wherein at least one of the detectors is a position sensitive detector.

3. The target of claim 1 wherein at least one of the detectors is a split detector that includes at least two detector cells separated by a gap.

4. The target of claim 1 wherein at least one of the detectors is a quad cell that includes four detector cells that are separated by a gap.

5. The target of claim 1 wherein the target housing includes a third target surface that is at an angle relative to the first target surface and the second target surface, and wherein the photo detector assembly includes a third detector that is secured to the third target surface.

6. The target of claim 5 wherein the target housing is shaped somewhat similar to a tetrahedron.

7. The target of claim 5 wherein the target housing includes a fourth target surface that is at an angle relative to the other target surfaces, a fifth target surface that is at an angle relative to the other target surfaces, and a sixth target surface that is at an angle relative to the other target surfaces; and wherein the photo detector assembly includes a fourth detector that is secured to the fourth target surface, a fifth detector that is secured to the fifth target surface, and a sixth detector that is secured to the sixth target surface.

8. The target of claim 7 wherein the target housing includes a seventh target surface that is at an angle relative to the other target surfaces, an eighth target surface that is at an angle relative to the other target surfaces, and a ninth target surface that is at an angle relative to the other target surfaces; and wherein the photo detector assembly includes a seventh detector that is secured to the seventh target surface, an eighth detector that is secured to the eighth target surface, and a ninth detector that is secured to the ninth target surface.

9. The target of claim 8 wherein the target housing is shaped somewhat similar to a decahedron.

10. The target of claim 8 wherein the target housing includes a tenth target surface that is at an angle relative to the other target surfaces, and an eleventh target surface that is at an angle relative to the other target surfaces; and wherein the photo detector assembly includes a tenth detector that is secured to the tenth target surface, and an eleventh detector that is secured to the eleventh target surface.

11. The target of claim 10 wherein the target housing is shaped somewhat similar to a dodecahedron.

12. The target of claim 1 wherein the beam is a fan beam.

13. A metrology system that monitors an object, the metrology system comprising: a transmitter that generates a moving beam, and the target of claim 1.

14. A metrology system that monitors an object, the metrology system comprising: a transmitter that generates a moving beam, a control system, and the target of claim 1; wherein the control system receives the first signal from the first detector and identifies when the beam impinges on the first detector, and receives the second signal from the second detector and identifies when the beam impinges on the second detector.

15. A method for manufacturing a structure, the method comprising the steps of: producing the structure based on design information; obtaining shape information of structure with the metrology system of claim 14; and comparing the obtained shape information with the design information.

16. The method of claim 15 further comprising the step of reprocessing the structure based on the comparison result.

17. The method of claim 16 wherein the step of reprocessing the structure includes the step of producing the structure over again.

18. A metrology system that monitors an object, the metrology system comprising:
a target including a target housing that is adapted to be secured to the object, and a photo detector assembly that includes a first detector having at least two detector cells that are separated by a gap, wherein each detector cell generates a cell signal;
a transmitter that generates a moving beam that is moved across the target; and
a control system that receives the cell signals from the first detector and identifies when the beam is directed at the gap.

19. The metrology system of claim 18, wherein the transmitter generates the moving beam that is a fan beam.

20. The metrology system of claim 18 wherein the target housing includes an engaging surface that is adapted to engage the object, a first target surface, and a second target surface that is at an angle relative to the first target surface; wherein the first detector is secured to the first target surface; and wherein the photo detector assembly includes a second detector that is secured to the second target surface.

21. The metrology system of claim 20 wherein at least one of the detectors is a quad cell that includes four detector cells that are separated by the gap.

22. The metrology system of claim 20 wherein the target housing includes a third target surface that is at an angle relative to the first target surface and the second target surface, and wherein the photo detector assembly includes a third detector that is secured to the third target surface.

23. The metrology system of claim 22 wherein the target housing includes a fourth target surface that is at an angle relative to the other target surfaces, a fifth target surface that is at an angle relative to the other target surfaces, and a sixth target surface that is at an angle relative to the other target surfaces; and wherein the photo detector assembly includes a fourth detector that is secured to the fourth target surface, a fifth detector that is secured to the fifth target surface, and a sixth detector that is secured to the sixth target surface.

24. The metrology system of claim 23 wherein the target housing includes a seventh target surface that is at an angle relative to the other target surfaces, an eighth target surface that is at an angle relative to the other target surfaces, and a ninth target surface that is at an angle relative to the other target surfaces; and wherein the photo detector assembly includes a seventh detector that is secured to the seventh target surface, an eighth detector that is secured to the eighth target surface, and a ninth detector that is secured to the ninth target surface.

25. The metrology system of claim 24 wherein the target housing includes a tenth target surface that is at an angle relative to the other target surfaces, and an eleventh target surface that is at an angle relative to the other target surfaces; and wherein the photo detector assembly includes a tenth detector that is secured to the tenth target surface, and an eleventh detector that is secured to the eleventh target surface.

26. A method for monitoring an object, the method comprising the steps of:
generating a moving beam with a transmitter; and
positioning a target near the object, the target including (i) a target housing having a first target surface, and a second target surface that is at an angle relative to the first target surface, and (ii) a photo detector assembly having a first detector secured to the first target surface and a second detector secured to the second target surface, each detector being adapted to detect if the beam impinges on it.

27. The method of claim 26 wherein the step of generating a moving beam includes the beam being a fan beam.

28. The method of claim 26 wherein the step of positioning includes at least one of the detectors being a split detector that includes at least two detector cells separated by a gap.

29. The method of claim 26 wherein the step of positioning includes at least one of the detectors being a quad cell that includes four detector cells that are separated by a gap.

30. The method of claim 26 wherein the step of positioning includes the target housing having a third target surface that is at an angle relative to the first target surface and the second target surface, and wherein the photo detector assembly includes a third detector that is secured to the third target surface.

31. The method of claim 30 wherein the step of positioning includes the target housing having a fourth target surface that is at an angle relative to the other target surfaces, a fifth target surface that is at an angle relative to the other target surfaces, and a sixth target surface that is at an angle relative to the other target surfaces; and wherein the photo detector assembly includes a fourth detector that is secured to the fourth target surface, a fifth detector that is secured to the fifth target surface, and a sixth detector that is secured to the sixth target surface.

32. The method of claim 31 wherein the step of positioning includes the target housing having a seventh target surface that is at an angle relative to the other target surfaces, an eighth target surface that is at an angle relative to the other target surfaces, and a ninth target surface that is at an angle relative to the other target surfaces; and wherein the photo detector assembly includes a seventh detector that is secured to the seventh target surface, an eighth detector that is secured to the eighth target surface, and a ninth detector that is secured to the ninth target surface.

33. The method of claim 32 wherein the step of positioning includes the target housing having a tenth target surface that is at an angle relative to the other target surfaces, and an eleventh target surface that is at an angle relative to the other target surfaces; and wherein the photo detector assembly includes a tenth detector that is secured to the tenth target surface, and an eleventh detector that is secured to the eleventh target surface.

34. The method of claim 26 further comprising the step of identifying when the beam is directed at a center of the first detector.

35. A method for manufacturing a structure, the method comprising the steps of: producing the structure based on design information; obtaining actual shape information of structure by using of the method of claim 26; and comparing the obtained shape information with the design information.

36. The method of claim 35 further comprising the step of reprocessing the structure based on the comparison result.

37. The method of claim 36 wherein the step of reprocessing the structure includes the step of producing the structure over again.
